(19) United States
(12) Patent Application Publication
(10) Pub. No.: US 2017/0109704 A1
(43) Pub. Date: Apr. 20, 2017

(54) SYSTEM AND METHOD FOR SCHEDULING AND FACILITATING WASTE REMOVAL

(71) Applicant: Recycle Track Systems Inc., New York, NY (US)

(72) Inventors: Gregory Lettieri, Guttenberg, NJ (US); Adam Pasquale, West New York, NJ (US)

(73) Assignee: Recycle Track Systems Inc., New York, NY (US)

(21) Appl. No.: 15/297,962

(22) Filed: Oct. 19, 2016

Related U.S. Application Data
(60) Provisional application No. 62/243,221, filed on Oct. 19, 2015.
(60) Provisional application No. 62/342,640, filed on May 27, 2016.

(51) Int. Cl. G06Q 10/10; G06Q 30/02

(52) U.S. Cl. CPC G06Q 10/1093; G06Q 30/0283; G06Q 50/26

(57) ABSTRACT

Systems, methods and apparatuses, including computer programs encoded on computer storage media, are disclosed that allow for the efficient scheduling, tracking and fulfillment of waste management services. The disclosed waste management system may receive waste management service requests from customers, provide price estimates for customers, allow waste management companies to automatically or manually assign service requests to hauler vehicles, generate optimal service routes for hauler vehicles, track hauler vehicle location and/or progress during service fulfillment, provide for dispute resolution, and/or assists in customer billing.

### CROSS-REFERENCE TO RELATED APPLICATIONS

The present application claims the benefit of U.S. Provisional Patent App. No. 62/243,221, titled “SYSTEM AND METHOD FOR SCHEDULING AND FACILITATING WASTE REMOVAL,” filed Oct. 19, 2015 and U.S. Provisional Patent App. No. 62/342,640, titled “SYSTEM AND METHOD FOR SCHEDULING AND FACILITATING WASTE REMOVAL,” filed May 27, 2016. Each of the above applications is incorporated by reference herein in its entirety.

### BACKGROUND

This specification relates to methods, systems and apparatuses that allow for the efficient scheduling, tracking, and/or management of services among service providers, their employees and contractors, and their customers.

Waste management is a vital service required by both residential and commercial customers. In the United States, household waste is generally left in waste containers or recycling bins prior to periodic collection by a municipal waste collector or a waste collector contracted by local government.

Unfortunately, municipal waste collectors often impose limits on the amount of waste that each residential customer can leave for pickup on a given day. Further, municipal waste collectors may not pick up waste items that exceed a certain size or mass (e.g. a sofa), or may require residential customers to dispose of such items on a particular day of the month. Accordingly, when residential customers wish to dispose of waste items that will not be picked up during a standard waste collection cycle, they must schedule a one-time or on-demand pickup. Commercial waste removal may be offered by some local governments, but it is generally performed by private waste removal companies. Still, commercial customers face many of the same limitations as residential customers.

Current technologies for scheduling waste management services and for providing such services to customers suffer from a number of drawbacks. First, scheduling a service can be difficult, because waste management companies may not have adequate support staff to answer calls or emails. To place a service order, customers may be required to email the company or leave a message on the company's voice messaging system and may be forced to wait until the hauler has an opportunity to return the email or call. The company may not return the customer's email or call for hours and, in some cases, may not return the email or call at all, requiring the customer to attempt to schedule the service the next day.

Second, the customer may be required to wait significant periods of time during the company's service window, which may be three hours or longer. Third, customers often have difficulty modifying service requests because waste management companies may lack adequate support staff to handle modifications and may not know the location and status of their own vehicles. Fourth, customers may experience missed service appointments because waste management companies lack a robust scheduling and monitoring system for their vehicles and because the customer may not be reminded of their appointment.

There remains a need for a robust waste management services scheduling system that would allow waste management companies and their customers to efficiently schedule and/or manage waste management services. It would be beneficial if the system could provide customers with the ability to order waste management services, modify such orders and/or receive information relating to such services. It would also be beneficial if waste management companies could use the system to create, modify and/or assign service requests to their employees. Finally, it would be beneficial if the system could determine optimized service schedules for waste management vehicles and/or provide navigation information to such vehicles.

### SUMMARY

In accordance with the foregoing objectives and others, methods, systems and apparatuses, including computer programs encoded on computer storage media, are provided for scheduling and facilitating waste management services.

In one embodiment, a computer-implemented method for scheduling and facilitating services is provided. The method includes receiving, by a computer, a service request associated with service request information, such as: a customer associated with the request, a requested service location, a requested service type, and/or a requested service time. A vehicle may be selected to fulfill the service request from a plurality of vehicles, where each vehicle may be associated with vehicle information, such as: one or more allowed customers, one or more allowed service locations, and/or one or more allowed service types. Each vehicle may also be associated with a service route that includes a number of scheduled service stops, where each stop may be associated with a service location and a service time. The selection of a vehicle may be based on the service request information and/or the vehicle information. The method may further include: determining, by the computer, an updated service route for the selected vehicle, the updated service route including a new service stop corresponding to the service request, the new service stop having a service time determined based on the requested service time and the vehicle information of the selected vehicle; transmitting, by the computer, the updated service route to the selected vehicle; receiving, by the computer, location information (e.g., from a location device associated with the selected vehicle); and determining, by the computer, that the vehicle has completed the new service stop, based on the received location information.

In another embodiment, a system for scheduling and facilitating services, is provided. The system may include a plurality of customer devices, each device associated with a customer; a plurality of dispatcher devices, each device associated with a dispatcher; a plurality of vehicle devices, each device associated with a vehicle and a sensor adapted to determine location information for the vehicle; and a server in communication with the plurality of customer devices, the plurality of dispatcher devices and the plurality of vehicle devices via a network. The server may include a memory that stores the location information associated with each of the plurality of vehicles; and/or vehicle information associated with each of the plurality of vehicles. Such vehicle information may include: one or more allowed customers, one or more allowed service locations, and/or one or more allowed service types. The vehicle information may additionally or alternatively include a service route having a number of scheduled service stops, where each stop may be associated with at least a service location and a service time. The server may also include a processor adapted to: receive a service request from one of the customer devices, the dispatcher devices, or the vehicle devices, where the service request includes service request information. Such information may include a customer associated with the request, a requested service location, a requested service type, and/or a requested service time. The processor may be further adapted to: select a vehicle to fulfill the service request from the plurality of vehicles, based on the received service request information and/or the stored vehicle information; determine an updated service route for the selected vehicle, where the updated service route may include a new service stop corresponding to the service request, and the new service stop may include a service time determined based on the requested service time and/or the stored vehicle information corresponding to the selected vehicle. Moreover, the processor may be adapted to transmit the updated service route to the vehicle device of the selected vehicle; and determine that the vehicle has completed the new service stop (e.g., based on the vehicle's location information).

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a system diagram of an exemplary waste management system.

FIG. 2 shows an exemplary companies list screen for a waste management application.

FIG. 3 shows an exemplary company details screen for a waste management application.

FIG. 4 shows an exemplary company contacts list screen for a waste management application.

FIG. 5 shows an exemplary company contact details screen for a waste management application.

FIG. 6 shows an exemplary company documents list screen for a waste management application.

FIG. 7 shows an exemplary company document details screen for a waste management application.

FIG. 8 shows an exemplary company vehicles list screen for a waste management application.

FIG. 9 shows an exemplary company vehicle details screen for a waste management application.

FIG. 10 shows an exemplary vehicle location device details screen for a waste management application.

FIG. 11 shows an exemplary vehicle location device map screen for a waste management application.

FIG. 12 shows an exemplary customers list screen for a waste management application.

FIG. 13 shows an exemplary customer details screen for a waste management application.

FIG. 14 shows an exemplary customer locations list screen for a waste management application.

FIG. 15 shows an exemplary customer location details screen for a waste management application.

FIG. 16 shows an exemplary location contacts list screen for a waste management application.

FIG. 17 shows an exemplary location contact details screen for a waste management application.

FIG. 18 shows an exemplary waste management services list screen for a waste management application.

FIG. 19 shows an exemplary waste details screen for a waste management application.

FIG. 20 shows an exemplary waste management service details screen for a waste management application.

FIG. 21 shows an exemplary waste management services list screen for a waste management application, where all scheduled and/or completed services are shown for a selected date.

FIG. 22 shows an exemplary waste management services list screen for a waste management application, where scheduled and/or completed services are shown for a selected date, grouped by hauler vehicle.

FIG. 23 shows an exemplary hauler vehicle service stop details screen for a waste management application.

FIG. 24 shows an exemplary hauler vehicle tracking screen for a waste management application.

FIG. 25 shows an exemplary hauler vehicle location map interface screen for a waste management application.

FIG. 26 shows an exemplary dashboard screen for a hauler vehicle application.

FIG. 27 shows an exemplary settings screen for a hauler vehicle application.

FIG. 28 shows an exemplary waste management services list screen for a hauler vehicle application.

FIG. 29 shows an exemplary waste management service details screen for a hauler vehicle application.

FIG. 30 shows an exemplary waste management services schedule list and map screen for a hauler vehicle application.

FIG. 31 shows an exemplary navigation screen for a hauler vehicle application.

FIG. 32 shows an exemplary sign-up screen for a customer application.

FIG. 33 shows an exemplary billing information screen for a customer application.

FIG. 34 shows an exemplary user-type selection screen for a customer application.

FIG. 35 shows an exemplary dashboard screen for a customer application.

FIG. 36 shows an exemplary settings screen for a customer application.

FIG. 37 shows an exemplary location selection screen for a customer application.

FIG. 38 shows and exemplary location creation screen for a customer application.

FIG. 39 shows an exemplary waste item selection screen for a customer application.

FIG. 40 shows an exemplary waste item details screen for a customer application.

FIG. 41 shows an exemplary waste management service request details screen for a customer application.

FIG. 42 shows an exemplary waste management service request submission screen for a customer application.

FIG. 43 shows an exemplary “take it all” screen for a customer application.

FIG. 44 shows an exemplary dashboard screen for a services provider application.

FIG. 45 shows an exemplary main menu screen for a services provider application.

FIG. 46 shows an exemplary task creation screen for a services provider application.

FIG. 47 shows an exemplary service request creation screen for a services provider application.

FIG. 48 shows an exemplary services list screen for a services provider application.

FIG. 49 shows an exemplary service overview screen for a services provider application.

FIG. 50 shows an exemplary comment log screen for a services provider application.

FIG. 51 shows an exemplary service details screen for a services provider application.

FIG. 52 shows an exemplary waste management service scheduling method.

### DETAILED DESCRIPTION

Various waste management systems, methods and apparatuses, including computer programs encoded on computer storage media, are discussed herein that allow for the efficient scheduling, tracking and fulfillment of waste management services. The disclosed embodiments may comprise a waste management server accessible via any number of client applications, including but not limited to, a waste manage application, a waste management services provider application, a hauler vehicle application and/or a customer application. The client applications may be present in the form of downloadable applications installable and executable on user devices such as a computers, smartphones, or tablets. Additionally or alternatively, the client applications may be available as one or more web applications, accessible via a client device having an interne browser.

As used herein, the term “waste management services” includes pickup, drop off, transport, disposal and/or maintenance services (e.g., fixing containers and/or cleaning after a pickup) relating to waste and/or waste management equipment. Waste encompasses all types of waste and debris, including but not limited to: household and commercial waste, large objects (e.g. furniture), recycled materials, and/or organics. And waste management equipment (or equipment) encompasses all types of equipment used to collect, store and/or transport waste (e.g., loose bags, one cubic yard container, two cubic yard container, etc.).

As used herein, a “waste management services provider” or “waste management company” refers to an entity who provides waste management services to customers. Each waste management services provider typically has access to one or more vehicles (also referred to herein as hauler vehicles or trucks) adapted to perform waste management services. Moreover, each company typically employs or contracts with one or more dispatchers who may create and/or route waste management service requests to one or more of a company's hauler vehicles.

### Waste Management System

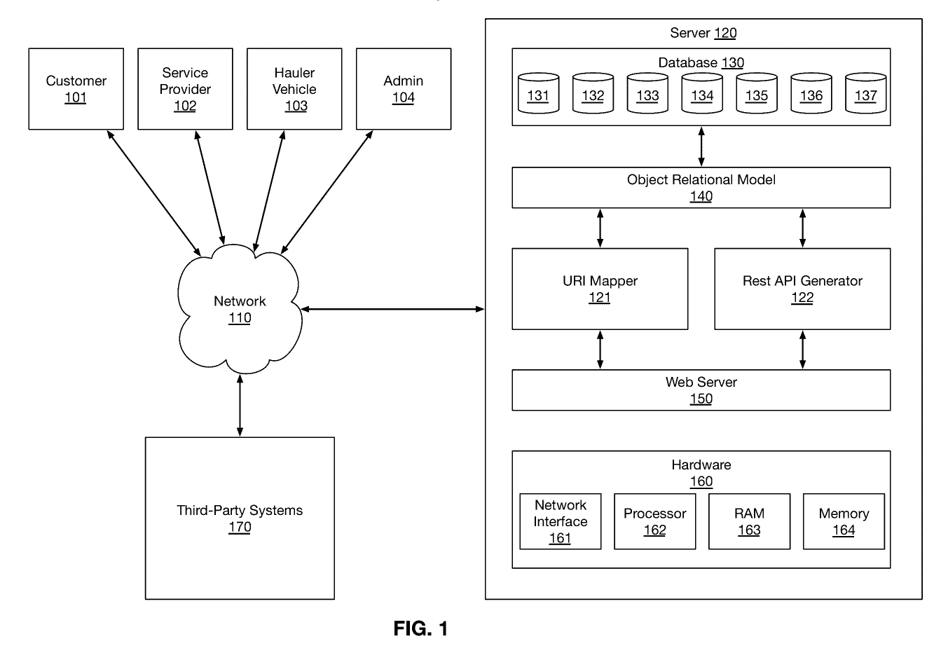

Referring to FIG. 1, an exemplary waste management system is illustrated. Generally, the waste management system includes a server 120 adapted to: receive waste management service requests from customers, generate price estimates for customers, allow waste management companies to automatically or manually assign service requests to hauler vehicles, generate optimal service routes for hauler vehicles, track hauler vehicle location and/or progress during service fulfillment, and/or assist in customer billing.

As shown, the system comprises any number of users (e.g., customers 101, waste management service providers 102, hauler vehicle operators 103, and/or system administrator users 104) accessing a server 120 via a network 110 (e.g., Internet, LAN, cellular, intranet, etc.).

In one embodiment, a waste management system may be entirely or partially implemented on one or more servers 120 comprising hardware 160 such as any number of processors 162, RAM 163 and internal or external memory 164. The server may include a network interface 161 such that it may access the network 110 to send or receive information.

As shown, at least one database 130 may be accessed by the server 120. Although shown as internal to the server 120, it will be appreciated that the database may be accessed by the server over a network or via another wired or wireless connection. The server may store desired or required information in the database 130 and may access the same to retrieve the information.

The database 130 may include a number of tables (131-137) adapted to store information relating to contacts and/or users (e.g., names, addresses, phone numbers, email addresses, usernames, passwords, admin privileges, etc.); waste management companies (e.g., contacts, locations, etc.); hauler vehicles (e.g., operator information, vehicle information, service information, location information, etc.); customers (e.g., contacts, locations, billing information, service history, etc.); service information (e.g., service types; requested and/or scheduled services); and waste information and/or equipment information (e.g., categories, items, dimensions, pricing, etc.). Accordingly, exemplary tables may include, but are not limited to, a contact table 131, a company table 132, a hauler vehicle table 133, a customer table 134, a service table 135, a waste table 136 and an equipment table 137. It will be appreciated that the illustrated tables are only exemplary and the data may be stored in a single database or any number of databases.

As shown, a database 130 may be in communication with an object relational mapping (“ORM”) 140, also known as an object relational model or object-relational database management system. Although shown as internal to the server 120, it will be appreciated that the ORM may be accessed by the server over the network 110 or via physical connection.

The ORM may be in communication with one or more of the following: a Universal Resource Indicator (“URI”) mapper 121, and a Rest API generator 122. First, the URI mapper may map a URI into a pointer to an internal program, view, logic, or presentation of data within the system, based on one or more rules of a matching object specified in a collection of mapping objects. The matching object may be a regular expression. The URI mapper may be in communication with a web server 150.

The Rest API generator 122 may be in communication with a web server 150 as to send and/or receive data to/from client devices (101, 102, 103) communicating with the server 120 using HTTP and/or HTTPS. The Rest API generator 122 may prepare data stored in the database 130 for delivery to a client device or may prepare data received from a client device for storage in the database. The Rest API may be capable of translating between formats including, but not limited to JSON, XML and the like. The Rest API may be capable of automatically generating URIs based upon data structures observed in the ORM for access by client devices.

A web server 150 may be adapted to deliver web pages on request to users using the Hypertext Transfer Protocol (HTTP and/or HTTPS) or similar protocols. This allows for delivery of HTML documents and any additional content that may be included by a document, such as images, style sheets and scripts.

In one embodiment, a user or client device (101-104) may employ a web browser or similar client application to engage in communication with a web server 150. For example, a client application may make a request for a specific resource using HTTP/HTTPS and the web server may respond with the content of that resource or an error message if unable to do so. The resource may be data or a file stored in a database 130. The web server can receive content from a user, possibly using HTTP/HTTPS.

In certain embodiments, a user may access the server 120 (i.e., a waste management application running on the server) through a user access device or client device (101-104) connected to a network 110. A user access device may be any device capable of accessing the server such as by running a client application or other software, like a web browser or web-browser-like application. In one embodiment, a user access device may comprise, for example, an input/output device, a display, a processor, memory, a location sensor, and/or audio equipment. Exemplary user access devices include, but are not limited to, general purpose computers, laptops, cell phones, smart phones, personal digital assistants, televisions, tablets, and the like.

Each of the user access devices (101-104) may have one or more client applications running thereon, where each client application may be adapted to communicate with a waste management application running on a server over, for example, a network. Such a configuration may allow users of client applications to input information and/or interact with the waste management application from any location that allows for access to the server.

As discussed in detail below, exemplary client applications include, but are not limited to: a waste management application, a customer application, a waste management service provider application, and/or a hauler vehicle application. Each of the client applications may be adapted to present various user interfaces to users. Such user interfaces may be based on access privileges and/or information sent by the waste management system, and may allow the user to send and receive data. As discussed in detail below, the various client applications may allow users to create, modify and/or cancel waste management services, as well as track the progress of such services. Each client application may comprise HTML data, images, icons, and/or executable code. The executable code may be composed in JavaScript, ECMAscript, coffeescript, python, Ruby or other programming languages suitable for execution within the client application, or translation into a client application executable form.

It will be apparent to one of ordinary skill in the art that, in certain embodiments, any of the functionality of a client may be incorporated into the server, and vice versa. Likewise, any functionality of a client application may be incorporated into a browser-based client, and such embodiments are intended to be fully within the scope of this disclosure. For example, a browser-based client application could be configured for offline work by adding local storage capability, and a native application could be distributed for various native platforms via a software layer that executes the browser-based program on the native platform.

In one embodiment, communication between a client application and the waste management application may involve the use of a translation and/or serialization module. A serialization module can convert an object from an in-memory representation to a serialized representation suitable for transmission via HTTP or another transport mechanism. For example, the serialization module may convert data from a native Python, Ruby, or Java in-memory representation into a JSON string for communication over the client-to-server transport protocol.

Similarly, communications of data between the client device (101-104) and the server 120 may be continuous and automatic, or may be user-triggered. For example, the user may click a button, causing the client to send data to the server. Alternately, a client application may automatically send updates to the server periodically without prompting by a user. If a client sends data autonomously, the server may be configured to transmit this data, either automatically or on request, to additional clients.

In one embodiment, the server 120 may be connected to one or more third party systems 170 via the network 110. Third party systems 170 may store information in one or more databases that may be accessed by the waste management server. Third party systems may include, but are not limited to, financial systems (e.g., billing, invoicing, and/or accounting systems), contact management systems, customer relationship management (“CRM”) systems, project and/or task management systems, calendaring systems, mapping systems, communication systems, and others.

The server 120 may be capable of populating database tables 130, with or without user interaction, by communicating with connected third party systems 170. Moreover, the server may be capable of communicating user-populated and/or automatically-populated database table entries to third party systems, and may notify users of such communications.

It will be recognized that any other suitable software, hardware or combinations thereof may be used with the exemplary waste management system and applications disclosed herein. Moreover, such applications may be implemented at any suitable location in FIG. 1, such as but not limited to at the server 120, a third party system 170, at one or more user devices (101-104) or at a location not shown.

### Waste Management Application

In certain embodiments, a waste management application may be provided to allow users to view, create, update and/or delete information relating to waste management companies, hauler vehicles, customers, contacts, locations, and/or services. The waste management application may be installed on (or accessed by) one or more client devices. For example, the waste management application may be in the form of a native desktop or mobile application and/or a web application. The waste management application may communicate with the waste management server via a network.

### Waste Management Services Providers

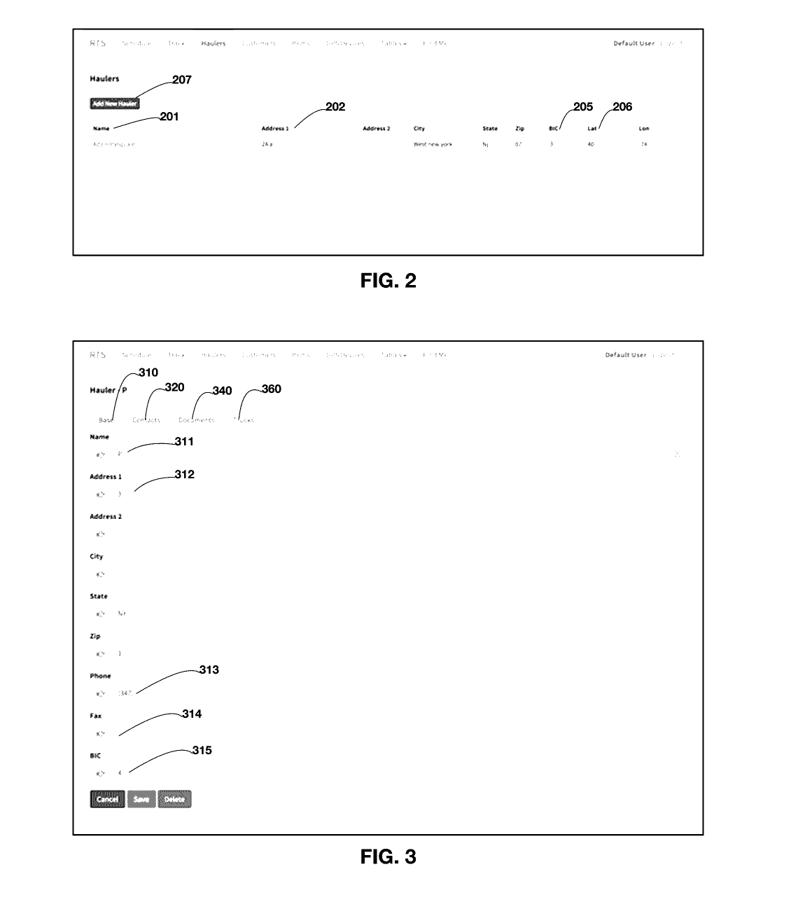

Referring to FIG. 2, an exemplary companies list screen for a waste management application is illustrated. As shown, the waste management application may store and/or display company information relating to each waste management companies. Such company information may include, but is not limited to: name 201, address 202, phone number, fax number, email address, and/or a Business Integrity Commission (BIC) permit number 205. The company information may also include latitude and longitude coordinates 206 representing a location where the company's hauler vehicles leave from and/or return to when not in use.

An additional waste management company may be added by, for example, clicking an “Add New Hauler” button 207, which opens a company details screen. Similarly, a user may view and/or edit company information by selecting any of the listed companies.

Referring to FIG. 3, an exemplary company details screen for a waste management application is illustrated. The company details screen allows a user to add, view, and/or edit company information for a waste management company.

An exemplary company details screen may include a number of sections (accessible via tabs) to view or input company information, such as but not limited to, a Primary tab 310, a Contacts tab 320, a Documents tab 340, and/or a Vehicles tab 360. As shown, the Primary tab may allow a user to view and/or edit company information, such as name 311, address 312, phone number 313, fax number 314, and/or a Business Integrity Commission (BIC) permit number 315. In one embodiment, a user may save changes to company information, cancel changes and/or delete the company.

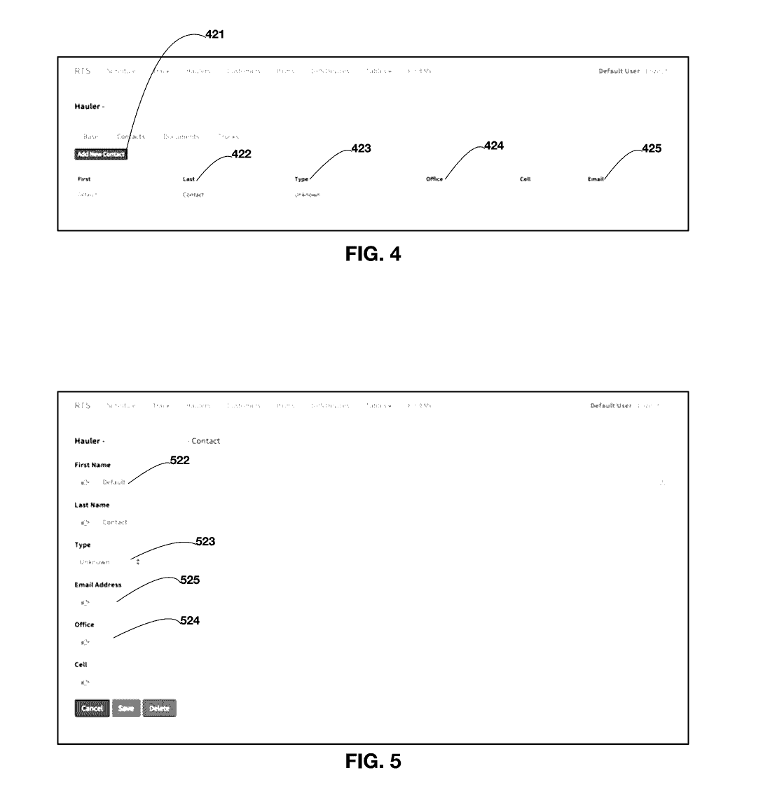

Referring to FIG. 4, an exemplary company contacts list screen for a waste management application is illustrated. The contact list screen may be accessible via the Contacts tab on the customer details screen (FIG. 3 at 320). This screen may display a list of contacts associated with a particular waste management company. Each company contact may be associated with contact information, such as but not limited to: name 422, contact type (e.g., dispatcher, packer dispatch, owner) 423, address, phone number 424, email address 425, and/or notification settings.

An additional contact may be added by, for example, clicking an “Add New Contact” button 421. Similarly, a user may view and/or edit a specific contact's information by selecting any of the listed contacts.

Referring to FIG. 5, an exemplary company contact details screen for a waste management application is illustrated. The contact details screen allows a user to add, view, edit and/or delete contact information associated with a contact for a particular waste management company. As shown, this screen may display the following contact information, which may be editable by a user: name 522, type 523, email address 525, and/or phone number 524. In one embodiment, the user may save changes to contact information, cancel changes and/or delete a company contact.

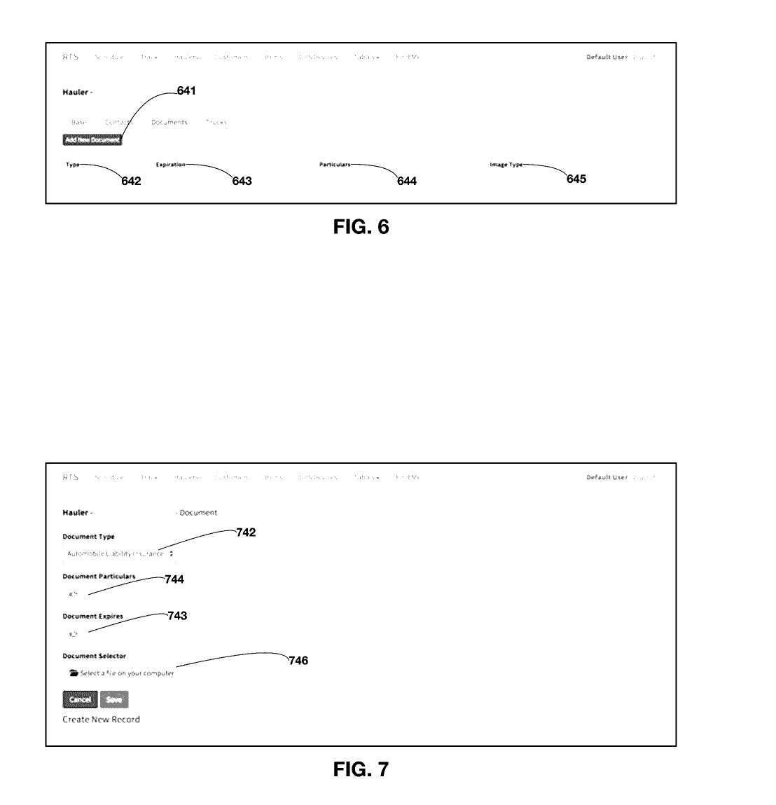

Referring to FIG. 6, an exemplary company documents list screen for a waste management application is illustrated. The documents list screen may be accessible via the Documents tab on the customer details screen (FIG. 3 at 340). This screen may display a list of documents associated with a particular waste management company. Each document may be associated with document information, such as: document type (e.g., automobile liability insurance, cargo liability insurance, general liability insurance, and/or others) 642; document expiration date (i.e., for legal documents) 643; document particulars (e.g., notes and/or important provisions) 644; and/or a document file type (e.g. PDF, DOC, JPG) 645.

An additional document may be added for a location by, for example, clicking an “Add New Document” button 641. Similarly, a user may view and/or edit a specific document's information by selecting any of the listed documents.

Referring to FIG. 7, an exemplary company document details screen for a waste management application is illustrated. As shown, the document details screen allows a user to add, view, and/or edit document information relating to a document. Document information may include, but is not limited to:: document type 742, document particulars 744, and/or document expiration date 743. A document selector feature 746 may be provided to allow a user to select and upload a document stored locally or remotely for upload. In one embodiment, the document selector 746 is a popup window that allows a user to access and select documents using the file system of the user's computer or other device. The user may save changes to document information, cancel changes and/or delete a document.

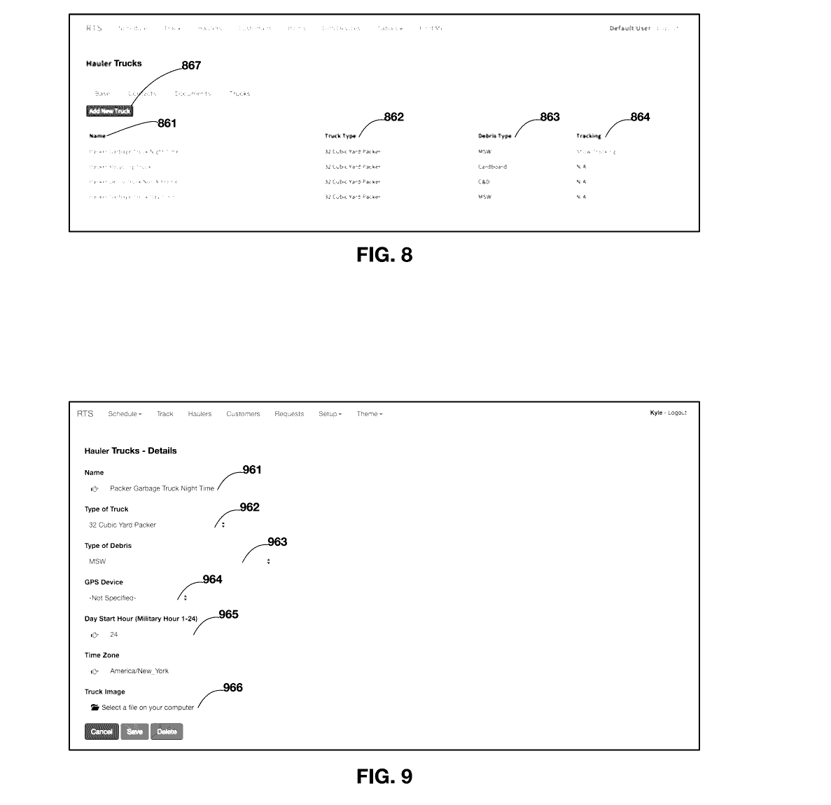

Referring to FIG. 8, an exemplary company vehicles list screen for a waste management application is illustrated. The vehicles list screen may be accessible via the Vehicles tab on the customer details screen (FIG. 3 at 360).

The vehicle list screen displays one or more waste management vehicles (also referred to herein as hauler vehicles or trucks) that are owned, controlled and/or at least partially managed by a waste management company. Hauler vehicles are used to fulfill waste management services, such as dropping off and/or picking up equipment.

As shown, each vehicle is associated with vehicle information, such as: vehicle name 861; vehicle type information 862, waste and/or equipment information 863, and a link to any stored tracking information 864. A user may add an additional vehicle for a waste management company by clicking an “Add New Truck” button 867. Similarly, a user may view and/or edit a specific vehicle's details by selecting any of the listed vehicles.

It will be appreciated that vehicle information is not necessarily limited to the information shown in the exemplary vehicles list screen. In certain embodiments, vehicle information may include, but is not limited to: vehicle name or identification number; vehicle type information; sensor information (e.g., a GPS device or other location device associated with the vehicle); one or more images of the vehicle; available times (e.g., days and times when the vehicle is available to perform waste management services); available locations; license plate information; and/or operator information (e.g., name, sex, age, address, phone, email address, license number, photo, etc.).

Vehicle type information may include, but is not limited to: waste type information (e.g., one or more types of waste that may or may not be carried by the vehicle); a waste capacity (e.g., volume and/or mass of waste); equipment type information (e.g., one or more types of equipment that a vehicle may or may not drop off and/or properties of such equipment); vehicle fuel capacity and/or a vehicle fuel efficiency. In certain embodiments, the system may store a number of vehicle types for selection by the user. Exemplary vehicle types include, but are not limited to: 25 cubic yard packer, 32 cubic yard packer, 32 cubic yard packer A-frame, rack truck, rolloff, rolloff with stinger, and others.

Referring to FIG. 9, an exemplary company vehicle details screen for a waste management application is illustrated. The vehicle details screen allows a user to add, view, and/or edit vehicle information relating to a particular waste management vehicle. As shown, an exemplary vehicle details screen may allow a user to view or edit vehicle information such as: vehicle name 961, vehicle type 962, waste and/or equipment information 963, sensor information 964, and/or available times 965. An image selector feature 966 is also present to allow the user to select and upload vehicle image files stored locally and/or remotely. In one embodiment, the document selector 966 is a popup window that allows a user to access and select images using the file system of the user's computer or other device. The user may save changes to vehicle information, cancel changes, and/or delete a vehicle.

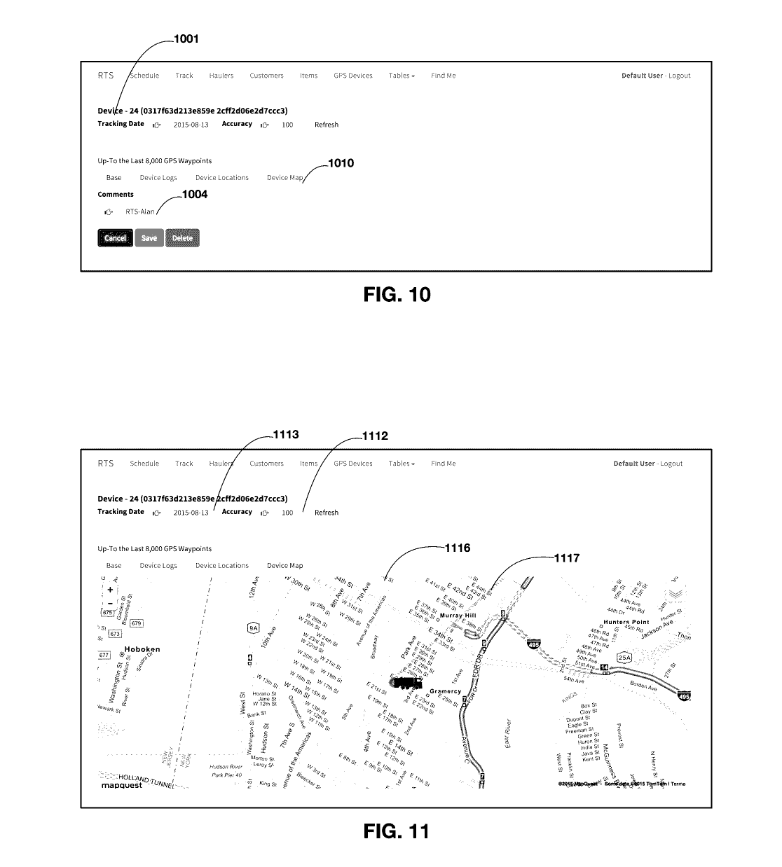

Referring to FIG. 10 and FIG. 11, exemplary vehicle location device screens are illustrated. These screens may be used to create, update, and/or delete location devices in the system. For example, a location device may be added to the system and then associated with a particular hauler vehicle (see FIG. 9 at 964).

Generally, each hauler vehicle is outfitted with a location device on which a hauling application is installed. GPS chips in these electronic devices (and/or additional GPS devices installed within a vehicle) are capable of triangulating the position of the electronic device using signals from military satellites and may provide the latitude, longitude, heading, speed, and/or accuracy of the position information. As shown, the system stores and/or displays location device information for each location device, allowing users to track hauler vehicles and manage location devices.

Referring to FIG. 10, an exemplary vehicle location device details screen for a waste management application is shown. The device details screen displays device information about a location device (e.g., hauler devices and/or GPS sensors). The device details screen may allow a user to change the name 1004 of a location device or delete the device from a list of devices. In one embodiment, the user may save changes to location device information, cancel changes, and/or delete a device.

In certain embodiments, the system may store and/or display vehicle location device information, such as but not limited to: a device name 1004; a unique device ID 1001, which may incorporate the device's model number and/or other data; location information (e.g., the location of the device/vehicle, including latitude, longitude, street, city and/or state); location update timestamp information (e.g., a time the location device updated the server with location information and/or an amount of time since the last location update); accuracy; creation date (e.g., a date a hauler application was first installed on a hauler device); and/or version information related to a currently installed hauler application or location device.

Referring to FIG. 11, an exemplary vehicle location device map screen for a waste management application is illustrated. This screen may be accessed, for example, by navigating to a Device Locations tab on the vehicle location device details screen (see FIG. 10 at 1010) As shown, this screen displays the location history 1117 for a particular location device on a selected date 1113 and/or its current location on a map 1116. The system may store and/or display information about the location of a location device over time, including a real-time or near-real-time location. The system may then display any number of the location data points, including but not limited to the date of creation, recorded latitude and longitude coordinates, speed, accuracy 1112, and/or compass heading.

### Customers

In certain embodiments, the waste management application may store and/or display information relating to one or more customers for each of the waste management services providers. Such customers may be residential (e.g., individuals, families, etc.) or commercial. And waste management services may be scheduled for customers at one or more customer locations.

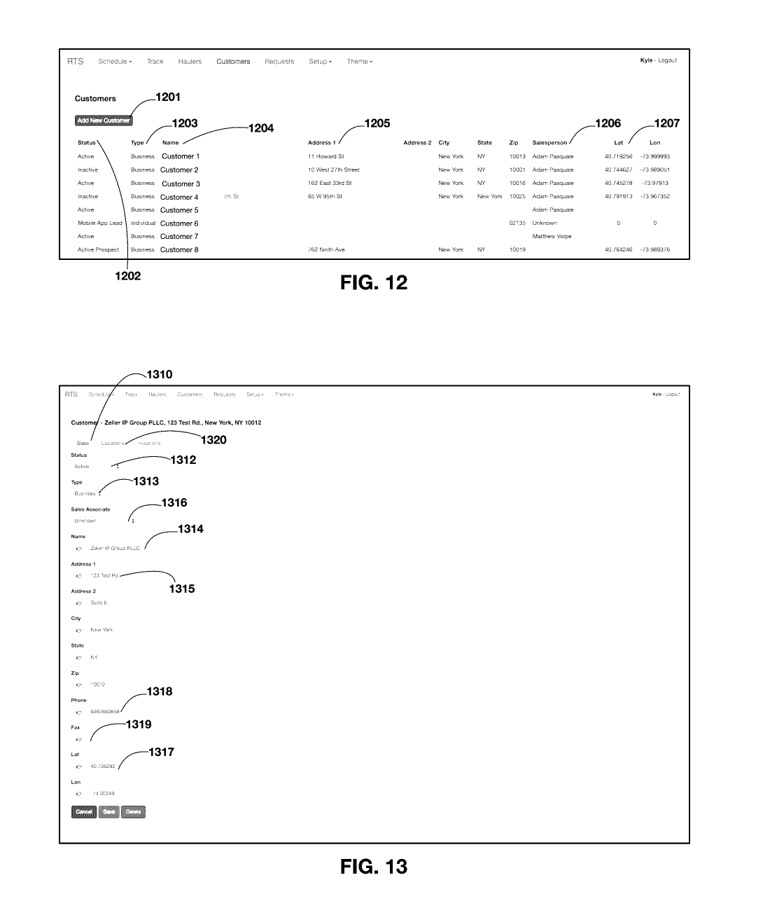

Referring to FIG. 12, an exemplary customers list screen for a waste management application is illustrated. As shown, a list of customers may be stored and/or displayed, where each customer may be associated with customer information.

In the illustrated embodiment, the following customer information may be displayed via the customer list screen: customer name 1204; customer address (physical address 1205 and/or latitude and longitude coordinates 1207) ; customer type (e.g., business or residential) 1203; customer status (active, inactive, new, priority) 1202; and/or a salesperson associated with the customer 1206. An additional customer may be added by clicking an “Add New Customer” button 1201, which opens a customer details screen. Similarly, a user may view and/or edit customer information by selecting any of the listed customers.

It will be appreciated that customer information is not necessarily limited to the information displayed in the customer list screen. In certain embodiments, customer information may include, but is not limited to: customer name; contact information (e.g., mailing address, phone number, fax number and/or email address); billing information (billing address, credit card information, billing phone number, etc.); customer type; customer status; a waste management company associated with the customer; a contact associated with the customer (e.g., a salesperson or account manager); service type (e.g., pickup or drop off); service information (e.g., waste management services that have been performed for the customer and/or that are requested by the customer); service location information (discussed in detail below); and/or documents associated with a customer (e.g., customer reports generated for and/or about the customer).

Referring to FIG. 13, an exemplary customer details screen for a waste management application is illustrated. The customer details screens may allow for customer information to be added, viewed, and/or edited for a particular waste management customer. An exemplary customer details screen may include a number of sections (accessible via tabs) to view or input customer information, such as but not limited to, a Primary tab 1310 and a Locations tab 1320.

As shown, the Primary tab 1310 may allow a user to view or edit customer information such as: customer status 1312; customer type 1313; sales associate information 1316; customer name 1314; customer address (physical address 1315 and/or latitude and longitude coordinates 1317); phone number 1318; and/or fax number 1319. In one embodiment, a user may save changes to customer information, cancel changes and/or delete a customer.

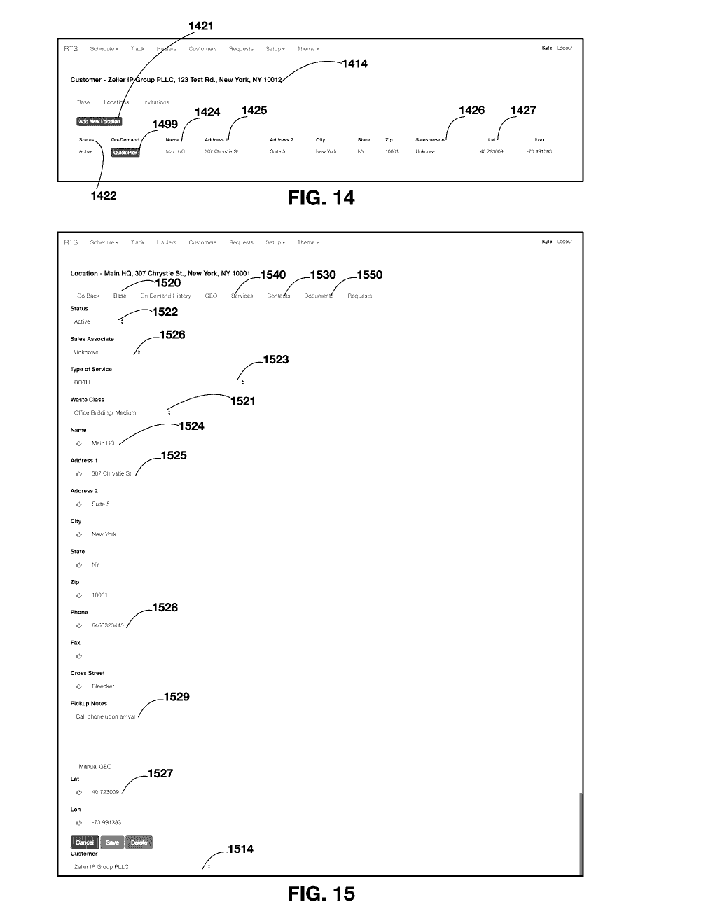

Referring to FIG. 14, an exemplary customer locations list screen for a waste management application is illustrated. The customer locations list screen may be accessible via the Locations tab on the customer details screen (FIG. 13 at 1320). This screen may display a list of one or more locations where the customer may require waste management services, wherein each of the locations may be associated with customer location information.

In the illustrated embodiment, the following location information is be displayed via the customer locations list screen: location status (active or inactive) 1422; a salesperson associated with the particular customer location 1426; location name 1424; location address information (physical address 1425, cross street, and/or latitude and longitude coordinates 1427). An additional customer location may be added by clicking an “Add New Location” button 1421, which opens a location information details screen. Similarly, a user may view and/or edit details of a specific customer location by selecting any of the listed locations.

It will be appreciated that customer location information is not necessarily limited to the information displayed in the exemplary customer location list screen. Each customer location may be associated with location information that may include, but is not limited to: location name; location address information (e.g., address, cross streets, and/or latitude and longitude coordinates); location contact information (e.g., phone number, fax number); location status; location type (e.g., commercial or residential, including type BIC business class); service type (pickup and/or drop off, waste type, equipment type); service information (e.g., waste management services that have been performed for the customer at the location and/or that are requested at the location by the customer); relationship information (broker, consultant or both); a non-customer contact associated with the location (e.g., a salesperson, broker, consultant, or account manager); a waste management company associated with the location; customer contacts associated with the location (e.g., name of contact, phone number, fax number, and/or email address); location notes; and/or location documents (e.g., images and/or reports associated with the location).

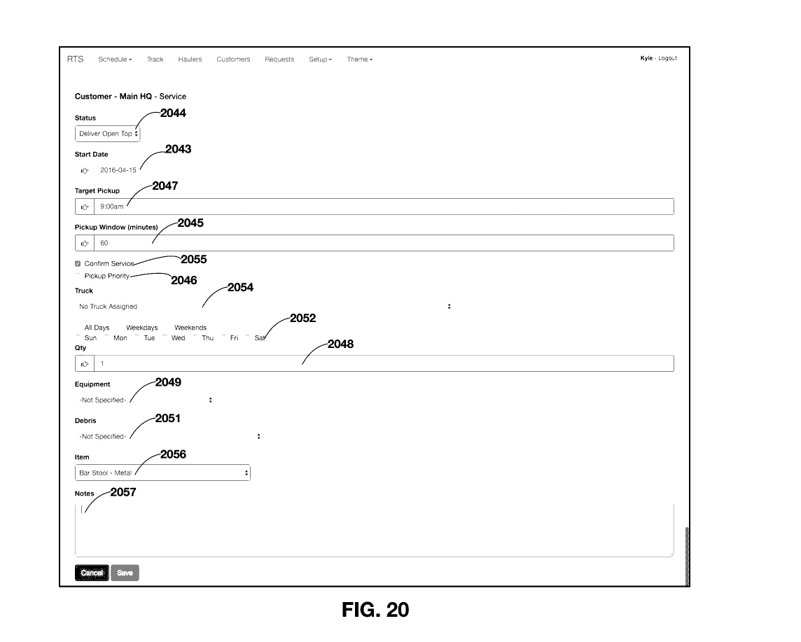

In one embodiment, a Quick Pick option 1499 may be displayed for one or more locations listed in the locations list screen. The Quick Pick option may allow a user to quickly schedule a waste management service for a customer location (see FIG. 20).

Referring to FIG. 15, an exemplary customer location details screen for a waste management application is illustrated. The location details screen allows a user to add, view, and/or edit location information relating to a customer location. An exemplary location details screen may include a number of sections (accessible via tabs) to view or input location information for a particular location, such as but not limited to, a Primary tab 1520, a Services tab 1540, a Contacts tab 1530, and/or a Documents tab 1550.

As shown, the Primary tab 1520 of the location details screen may allow a user to view or edit location information such as: location status 1522; a salesperson associated with the particular location 1526; relationship information associated with the location 1523; location type 1521; location name 1524; location address information (physical address 1525 and/or latitude and longitude coordinates 1527); location phone number 1528; location notes 1529; and/or the customer associated with the location 1514. In one embodiment, the user may save changes to the location information, cancel changes and/or delete a location.

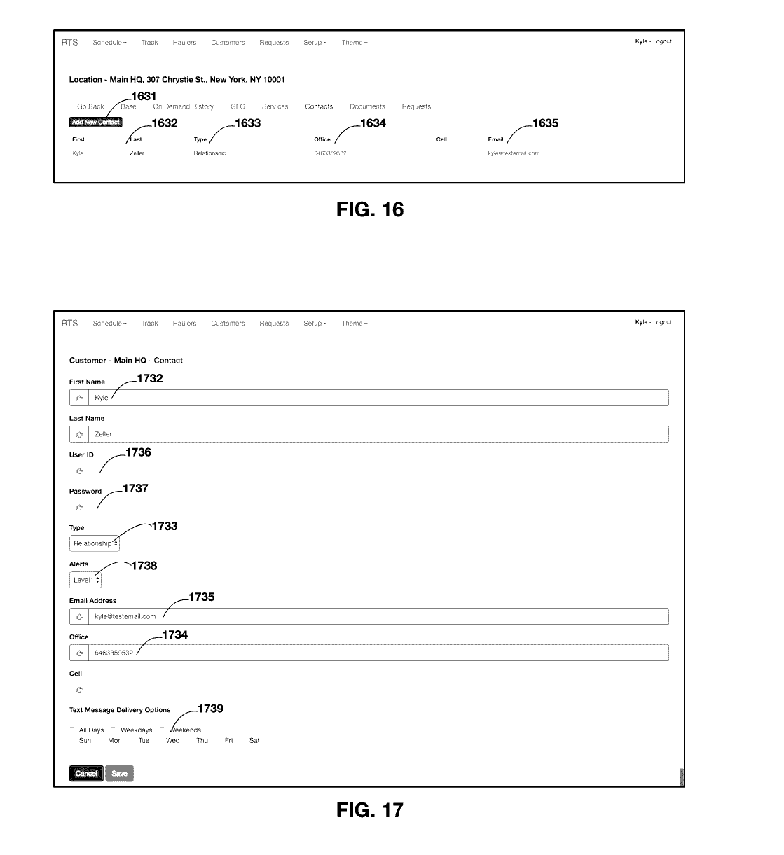

Referring to FIG. 16, an exemplary location contacts list screen for a waste management application is illustrated. The contacts list screen may be accessible via the Contacts tab on the customer location details screen (FIG. 15 at 1530). This screen may display a list of contacts associated with a particular customer and/or customer location, where each contact is associated with contact information.

In the illustrated embodiment, the following contact information may be displayed via the contacts list screen: contact name (e.g., first name and last name) 1632; contact type (e.g. Manager, Owner, Service Team Leader, Relationship, Other) 1633; phone number (e.g., office and cell) 1634; and/or email address 1635. Additional contacts may be added for a location by clicking an “Add New Contact” button 1631. Similarly, a user may view and/or edit a specific contact's details by selecting any of the listed contacts.

Referring to FIG. 17, an exemplary location contact details screen for a waste management application is illustrated. The contact details screen allows a user to add, view, or edit contact information associated with a contact for a particular customer location. As shown, the contact details screen may allow a user to view or edit contact information such as: contact name 1732, contact type 1733, phone number 1734, email address 1735, user ID 1736, password 1737, notification settings 1739, reports settings 1738, and/or dispute resolution settings. In one embodiment, the user may save changes to contact information, cancel changes, and/or delete a contact.

In certain embodiments, a location documents list screen and/or document details screen may be accessible via the Documents tab on the customer location details screen (FIG. 15 at 1550). This screen may display a list of documents associated with a particular customer location, where each document is associated with document information. The following document information may be displayed via the documents list screen: document type (e.g., insurance certificate, contract between broker and customer, contract between customer and waste removal provider, survey, images, and/or others); document expirations date (i.e., applicable to contracts); document particulars (e.g., notes or important contract provisions); document file type (e.g., PDF, DOCX, JPG, etc.). A user may add an additional document for a location, edit document information, save changes, cancel changes and/or delete a document. A document selector feature may be provided to allow a user to select and upload a document stored locally or remotely for upload.

### Waste Management Services

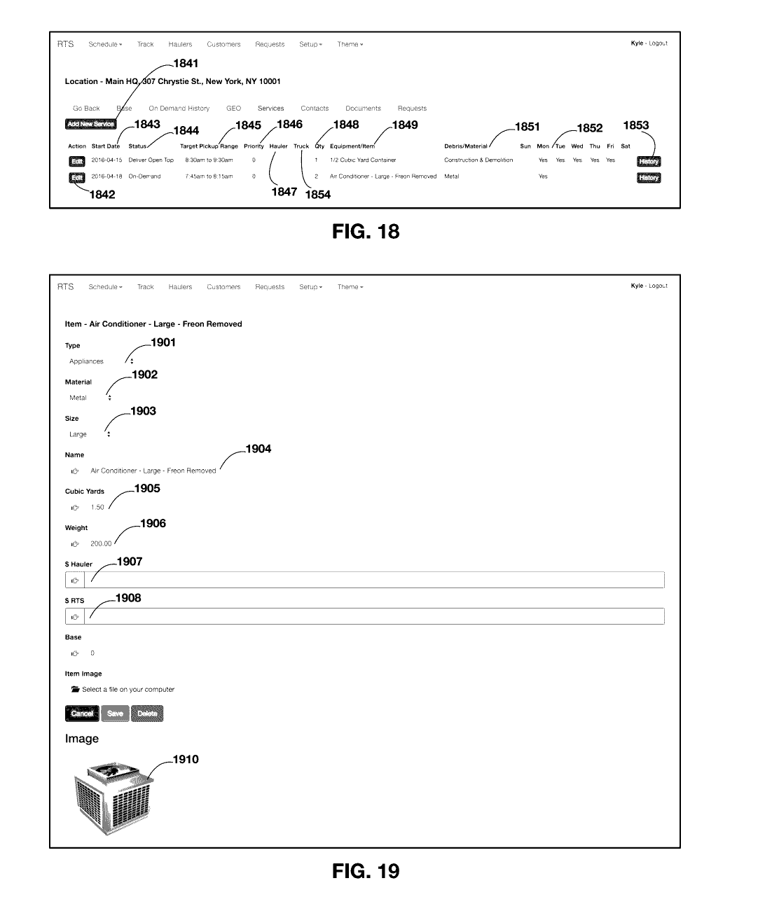

Referring to FIG. 18, an exemplary waste management services list screen for a waste management application is illustrated. The services list screen may be accessible via the Services tab on the location details screen (FIG. 15 at 1540). This screen may display a list of services associated with a particular customer location, where each service is also associated with service information.

In the illustrated embodiment, the following waste management service information may be displayed via the services list screen: service status (e.g., available, requested, scheduled, and/or completed) 1844; waste information (discussed below) 1851; equipment information (discussed below) 1849; quantity of waste or equipment 1848, service scheduling information (e.g., one-time service or recurring service) 1852; service date(s) and time(s) (may include start date/time 1843, end date/time, target pickup, and/or pickup window 1845); priority information 1846, company information 1847 relating to the company who will fulfill the request (e.g., company contact, etc.); and/or hauler vehicle information 1854 relating to a vehicle assigned to perform the service. Additional services may be scheduled for a location by clicking an “Add New Service” button 1841, which opens a service information edit screen (see FIG. 20). Similarly, a user may view and/or edit service information for a specific service by selecting it from the list or selecting an “Edit” option 1842.

In one embodiment, a service history screen may be accessed by clicking the “History” button or link 1853. The service history screen may include a list of a customer's services over time, where each service may be associated with a status, such as completed, missed, and/or cancelled.

It will be appreciated that service information is not necessarily limited to the information displayed in the exemplary services list screen. In certain embodiments, each service may be associated with service information, including but not limited to: service type (e.g., waste pickup, equipment pickup and/or equipment drop off); waste information; equipment information; service scheduling information; service date(s) and time(s); service length (estimated and/or actual time required to perform the service); service location; customer information; company information; hauler vehicle information; service status; service history information; service creation and/or cancellation date; service creator information (e.g., a customer contact, vehicle operator, company contact or admin user who created the service); priority information; service notes; and/or images relating to the service (e.g., location, waste, equipment, vehicle and/or dump slip images).

For a waste pickup service, waste information may be stored by the system, displayed to a user, received by a customer and/or determined. As shown in the exemplary waste details screen illustrated in FIG. 19, waste information includes information relating to bulk waste and/or individual items. Such waste information may include, but is not limited to: waste item name or unique ID 1904; waste category (e.g. appliances, furniture, loose bags & bulk, mixed construction and demolition (C&D)) 1901; waste material (e.g., cardboard, co-mingled recycling (GMP), organic, concrete, brick, tile, glass, metal, plastic, municipal solid waste (MSW), drywall, electronic, fiberboard, mixed C&D, paper, tire, wood and/or others) 1902; waste size (e.g., small, medium, large, and/or extra-large) 1903; mass 1906 per given volume 1905 (estimated and/or actual); recyclability; waste price (e.g., price per quantity, volume or mass a customer may be charged for waste pickup) 1908; waste cost (e.g., price per item, volume or mass a user pays to have a hauler vehicle pick up waste) 1907; and/or waste images (e.g., one or more images of the waste stored in the system and/or received by a customer) 1910. Such waste information may be used to determine what hauler vehicle (or waste management company) may qualify to fulfill a service request.

Generally, each waste item may be associated with one or more waste categories. For example, a toaster or a blender may be associated with an “appliances” category. As another example, a couch may be associated with a “furniture” category.

For an equipment drop off order, equipment information may be stored by the system, displayed to a user, received by a customer and/or determined. Equipment information is substantially similar to waste information, and such information may include, but is not limited to: equipment name or unique ID; equipment category; equipment type; equipment dimensions (height, width, length); equipment mass; equipment capacity (i.e., mass and/or volume of waste the equipment is capable of holding); allowed or non-allowed waste; equipment drop off price (per-unit price); equipment drop off cost (price per quantity a customer may be charged for equipment drop off); equipment drop off cost (price per quantity a user pays to have a hauler vehicle drop off the equipment); equipment pickup price (e.g., price per quantity or mass a customer may be charged for equipment pickup); and/or equipment pickup cost (e.g., price per quantity or mass a user pays to have a hauler vehicle pick up the equipment). Equipment information may be used to determine what hauler vehicle (or waste management company) may qualify to fulfill a service request

Referring back to FIG. 18, a service may be classified as being a priority 1806. Such services may be displayed prominently to a hauler vehicle operator via the hauler application (e.g., via a notification or the like). Moreover, a priority indication may be factored into route optimization. For example, if a time period to execute a service is running out, the system may re-route the driver to the priority stop. Additionally or alternatively, marking a stop as a priority may also send an alert (e.g., push notification, email, SMS) to a system administrator, dispatcher and/or a hauler vehicle operator if it has not been picked up within a certain amount of time before the service time window ends (e.g., 1 hour).

Referring to FIG. 20, an exemplary waste management service details screen for a waste management application is illustrated. As shown, the service details screen may allow a user to add, view and/or edit service information relating to a scheduled and/or requested service. Such service information may include, but is not limited to: service status 2044; start date 2043; target pickup time 2047; pickup window 2045; service days 2052; service confirmation 2055; priority information 2046; waste information 2051; equipment information 2049; quantity of waste/equipment 2048; item of waste/equipment 2056; and/or notes 2057 relating to the service. The user may save changes to service information, cancel changes and/or delete a service.

As shown, a service may include a confirmation request 2055. This may cause the service to be made prominent to a vehicle operator on the hauler tablet application so they are aware a stop has been added. An alert may only show up on a first occurrence of the service (or during the first week of a new service), and the operator can confirm they received information about the new service using the hauler application (discussed below).

In one embodiment, a service may be manually assigned to a waste management vehicle. As shown, a list of hauler vehicles 2054 may be presented to the user for manual selection.

In one embodiment, the list may be automatically filtered to remove vehicles that do not meet the requirements of the requested service and/or vehicles that may not be accessed by a particular user. For example, a dispatcher associated with a company may only route a service request to one of the company's hauler vehicles, so vehicles belonging to a different company may not be shown. As another example, an admin user may route a service request to a hauler vehicle associated with any company, so multiple companies' vehicles may be displayed.

In other embodiments, a service may be automatically assigned to a hauler vehicle by the system. As discussed in detail below, the system may determine an appropriate or optimal waste management company and/or hauler vehicle to fulfill the requested service. The system may schedule the service and provide any desired or required notifications.

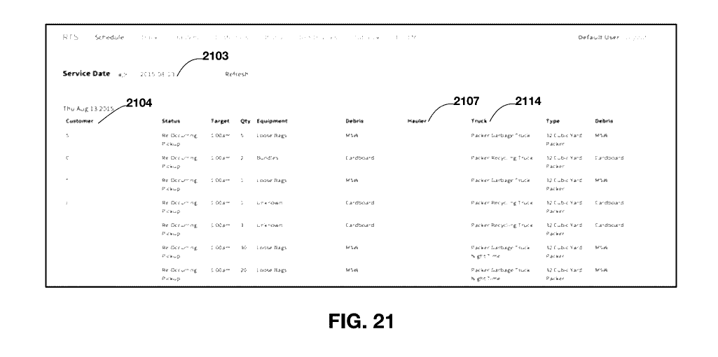

Referring to FIG. 21, an exemplary waste management services list screen for a waste management application is illustrated, where all scheduled and/or completed services are shown for a selected date 2103. As shown, each of the scheduled services may be displayed and filter by, for example, service date 2103, customer 2104, waste management company 2107, assigned hauler vehicle 2114, and other service information. This screen allows a user to view services scheduled for and/or completed on a particular day, for one or more customers and/or for one or more customer locations.

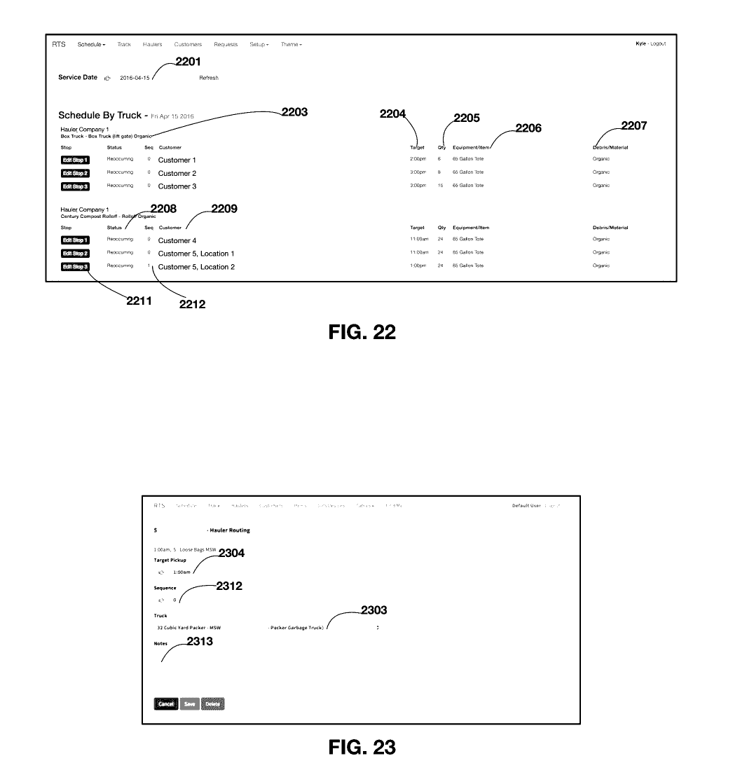

Referring to FIG. 22, an exemplary waste management services list screen for a waste management application is illustrated, where scheduled and/or completed services are shown grouped by hauler vehicle 2203 for a selected date 2201. In one embodiment, the application displays individual schedules for each hauler vehicle 2203, as well as a combined services schedule for all hauler vehicles. Service information for each stop on the schedule may be displayed, including customer information 2209, target service time 2204, waste information 2207, equipment information 2206, quantity information 2205, service status 2208 and/or sequence information 2212 (discussed below). In one embodiment, a user may edit a scheduled service stop by, for example, selecting an “Edit Stop” option 2211. In another embodiment, the user may adjust the order of a hauler vehicle's service stops by, for example, dragging one stop from a first position to a second position above or below the first position. Any change in service stop order may be transmitted to a hauler vehicle device and reflected in a list of service stops displayed via the hauler vehicle application (discussed in detail below).

Referring to FIG. 23, an exemplary hauler vehicle service stop details screen for a waste management application is illustrated. This screen allows a user to edit information relating to one of a hauler vehicle's scheduled services (i.e., service stops), including pickup time 2304 and notes 2313. A user may save changes to the service stop information, cancel changes and/or delete a stop.

In one embodiment, a user-editable sequence field 2312 may be displayed. This field pertains to customers who are serviced more than once during a vehicle's route (e.g., in the morning and in the afternoon), and the sequence number denotes which stop the vehicle is making. A sequence number of “0” denotes the first time a vehicle stops at a location on a particular route. A sequence number of “1” denotes the second time the vehicle stops at the location on the same route.

In another embodiment, a user may assign a different hauler vehicle to the service request via the vehicle field 2303. This field may contain a filtered list of a company's vehicles that are capable of performing the service. Selection of a different vehicle from the list will result in unassigning the service from one vehicle and assigning the service to the selected vehicle.

### Hauler Vehicle Tracking

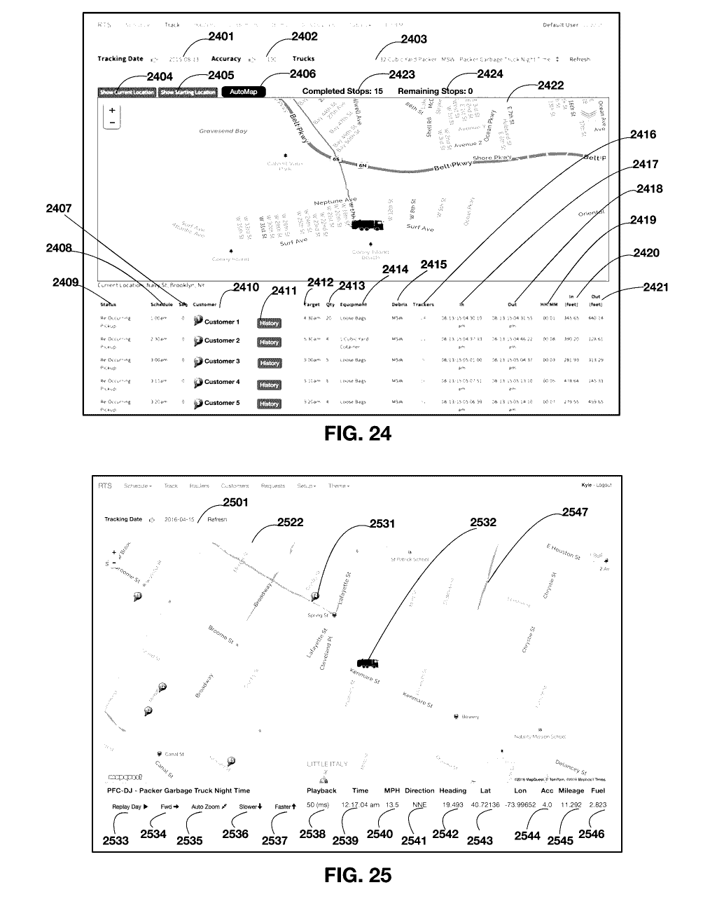

Referring to FIG. 24 and FIG. 25, exemplary vehicle tracking screens are illustrated. As discussed above, the waste management system may receive and store vehicle information comprising at least vehicle location information and other vehicle sensor information. Such vehicle information may be displayed to one or more users and/or may be employed to trigger a number of actions. In certain embodiments, past, present and/or projected vehicle information may be displayed for one or more hauler vehicles.

Referring to FIG. 24, a list of service stops for a particular hauler vehicle 2403 on a selected date 2401 is displayed. As shown, the list may include service stop information, such as but not limited to: recurring status (e.g., recurring or one-time service) 2409; scheduled service time (e.g., pickup or drop off time of next vehicle stop) 2408; sequence number 2407; customer name 2410; target service time 2412; waste information; 2415; equipment information 2414; waste/equipment quantity 2413; number of location device data points received (e.g., starting from the time the vehicle is within a predefined distance of a stop) 2416; service start time (i.e., the time a vehicle arrived at a particular service location) 2417; service end time (i.e., the time a vehicle left a particular service location) 2418; service duration (the amount of time a vehicle was at a particular service location) 2419 and/or accuracy 2402.

In certain embodiments, the system may store and/or display a distance from the service location that the vehicle's location device first detects that the vehicle is within a predefined distance of the stop 2420. For example, if the location device reading were 100% accurate and in real-time, this value would always be equal to the predefined distance. However location device data may not be received in real-time in some instances, so a vehicle may travel closer to a scheduled service location than the defined boundary before the location device detects that the vehicle is within the limit. Similarly, the system may store and/or display a distance from the service location that the vehicle's location device detects that the vehicle is more than a predefined distance from a scheduled service location 2421.

As shown, the list may be filtered by date 2401, accuracy 2402 and/or hauler vehicle 2403. For example, a user may select a hauler vehicle from a dropdown list of vehicles.

The user may then view real-time information relating to the selected vehicle's location and/or view historical location information by entering a particular date in the date field. For example, a number of completed stops 2423 and/or remaining stops 2424 may be displayed.

Additionally or alternatively, the vehicle's real-time or historical location information may be displayed via a map interface 2422. The user may view the vehicle's current location by, for example, selecting the “Show Current Location” option 2404. The user may view the vehicle's starting location for a particular date by, for example, selecting the “Show Starting Location” option 2405.

It will be appreciated that elements of the above described information may be manually entered into the system. For example, a user and/or any received information sent by a user of a customer application or a hauler application.

The system may additionally or alternatively determine elements of the above described information. As discussed below, service start time, service end time, service duration, service completion and/or other information may be determined based on received vehicle location information, with or without additional user input.

Referring to FIG. 25, an exemplary vehicle location map interface screen for a waste management application is illustrated. This screen may be accessed by, for example, selecting an “AutoMap” option (see FIG. 24 at 2406). As shown, historical vehicle location information 2547 may be displayed via a mapping interface 2522. A user may enter a date into a date field 2501 to view historical location information for a particular hauler vehicle on that date. The location information may be in video format, where a representation of the vehicle 2532 is shown traveling on a map 2522 to/from each stop 2531. The user may view the vehicle's route for the selected day by selecting the “Replay Day” option 2533. The user may increase the speed of the video by selecting the “Fwd” option 2534 and/or decrease the speed of the video by selecting the “Slower” option 2536. Controls may also be present to allow the user to manually zoom and/or auto zoom 2535.

As shown, the system may store and/or display vehicle information, including: vehicle name; playback time of the video 2538; a time 2539 corresponding to the currently shown position of the vehicle on the map; vehicle speed at the time 2540; vehicle direction at the time (2541, 2542); vehicle position coordinates at the time (i.e., longitude and latitude) 2543; location device accuracy 2544; vehicle acceleration at the time; mileage at the time 2545 and/or fuel information 2546 (e.g., fuel used during the date, fuel left in the vehicle's tank, etc.). Such information may be shown for each data point received from a location device on the specific date selected 2501.

Although not shown, the system may track, store and/or display additional analytics relating to one or more hauler vehicles. Such analytics may include, for example: hauler vehicle fuel usage (e.g., total fuel used and/or average miles per gallon); vehicle idling; service stops completed; service stops missed; questionable service stops (e.g., location device was close but not certain); atypical or unscheduled vehicle stops; excessive time taken at a vehicle service stop; speeding; vehicle uptime/downtime; distance traveled (e.g., total distance, distance between each stop, etc.); actual vs estimated travel time; actual vs estimated travel distance; estimated vehicle fullness (based on service level information) vs. actual dump ticket; and/or estimated return on the stop (based on estimated/surveyed bags counts/weights and time to service the stop). Any of the above information may be displayed to a user of the waste management system, such as a waste management company user or an admin user. Additionally or alternatively, such information may be provided to a user in the form of a report.

It will be appreciated that that the waste management application may typically be accessed by an administrative user. However, in certain embodiments, one or more users associated with a waste management company may be given access to the waste management application. Such users may only have access to information relating to their own company, rather than to all companies. Moreover, although not shown, a waste management company user may add their company to the system through a signup process.

One or more customers may also be given limited access to the waste management application. It will be appreciated that such users may only have access to information relating to their own account (e.g., services, locations, users), rather than to waste management services providers or other customers. For example, customers may access and/or edit customer reports, account information (e.g., billing information, service locations, and services scheduled and completed), notifications, order creation and/or ticketing (for container fixes, etc.). Additionally customers may be able to add/edit contacts to receive email or SMS notifications upon arrival, as well as manage who can create orders on the customer/company's behalf (and for which locations). Although not shown, a customer may add themselves to the system through a signup process.

### Hauler Vehicle Application

In one embodiment the waste management system comprises a hauler vehicle application installed on one or more mobile devices, each device associated with a hauler vehicle. The hauler application may communicate with the server via a network, such as a cellular network or Wi-Fi network.

Generally, hauler vehicle operators may interact with the hauler application to view scheduled services, view turn-by-turn directions, and/or receive and send communications relating to services. The hauler application may track vehicle status information (e.g., location, speed, pickup status, etc.) via one or more sensors in communication with the application and the vehicle, and such information may be transmitted to the server via a network.

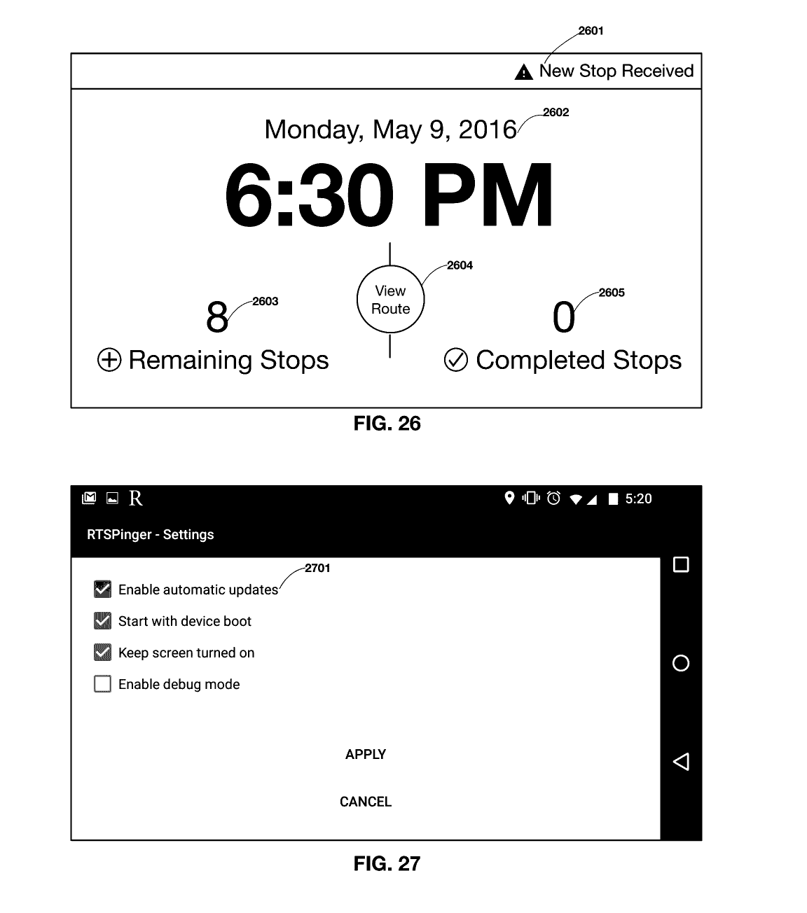

Referring to FIG. 26, an exemplary dashboard screen for a hauler vehicle application is illustrated. As shown, the dashboard may display one or more upcoming service stops 2603, completed stops 2605, notifications 2601, a clock face 2602, an option to view an optimized route to the next service location 2604, and/or other relevant information. In some embodiments, the hauler application dashboard may show exceptional stops, such as priority stops, new stops, on-demand pickups, or stops that were missed.

The dashboard may show additional information such as but not limited to: notes from customers, dispatchers and/or admin users; on-site contact information; estimated completion time; hold stops and/or stops removed (e.g., in the case of service suspended/credit hold); nearest and/or most accessible applicable waste/recycling facility; and/or a map, street view and/or image of an exact service location (e.g., for rolloff containers, where exactly to drop the container). In one embodiment, the dashboard may provide a feature to allow the hauler to speak directly with the dispatcher, via cellular service, VoIP or two-way radio.

Referring to FIG. 27, an exemplary settings screen for a hauler vehicle application is illustrated. The settings screen may present a number of user-adjustable settings 2701, including but not limited to, sound options, display options, startup options, update options, GPS settings, night/day mode, operator log in/out, and/or operator information (e.g., name, phone number, email, address, password, etc.).

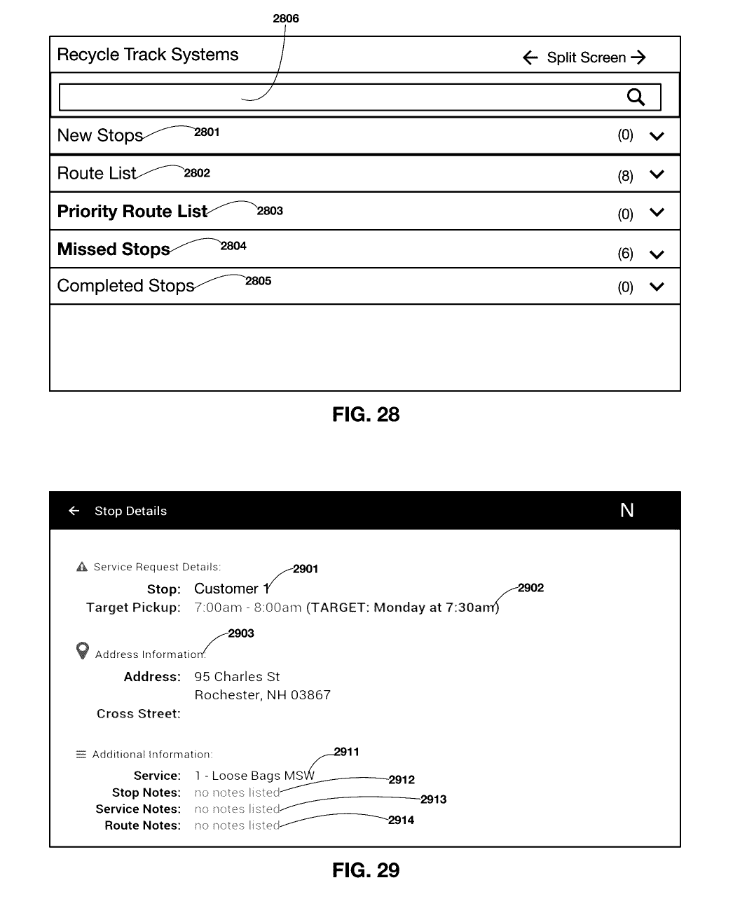

Referring to FIG. 28, an exemplary waste management services list screen for a hauler vehicle application is illustrated. Generally, the hauler application displays a list of scheduled services for the hauler vehicle to complete. Each of the scheduled services comprise service information, including but not limited to waste information, equipment information, location information and/or pricing information (e.g., an estimate of the price that will be paid by the customer). The services list screen allows a hauling vehicle operator to see a list of stops that have been scheduled for a particular vehicle. In certain embodiments, the stops may be grouped into lists such as: new stops 2801, route list 2802, priority route list 2803, missed stops 2804 and/or completed stops 2805. Additionally or alternatively, a search feature 2806 may be provided to allow searching for specific service stops.

Referring to FIG. 29, an exemplary waste management service details screen for a hauler vehicle application is illustrated. As shown, the following service information may be displayed: customer name 2901, service location (e.g., customer address) 2903; waste information and/or equipment information (e.g., item type(s), item quantity and/or any item or order details attached by the customer and/or dispatcher) 2911; stop notes 2912; service notes 2913; route notes 2914; distance from current vehicle location to customer location; and/or scheduled service time (or time window) 2902. In certain embodiments, a pinned map, street view image, and/or camera photo may be displayed for a service stop to help operators navigate to the correct location.

As discussed above, the service location for each hauler vehicle may be automatically determined via the waste management system and transmitted to the hauler application via a network. Such jobs may be received directly from customers (e.g., via a customer application) or from any party that has access to the waste management application (e.g., dispatchers or other administrators).

Although not shown, the hauler application may also allow a user of the application to manually add a service for a customer. The service may be entered (e.g., by a hauler vehicle operator) and then may be sent via a network to the waste management application and/or dispatcher application to be added to the hauler vehicle services schedule. Accordingly, similar features to those described above (i.e., hauler vehicle tracking, customer notifications, etc.) may be available for jobs scheduled via the hauler application.

Referring to FIG. 30, an exemplary waste management services schedule list and map screen for a hauler vehicle application is illustrated. This screen allows a hauler vehicle operator to see the above described information in a list 3001, along-side a map 3002 showing the locations of those stops 3003 and/or the current location of the vehicle 3005.

In practice, an operator of the hauler vehicle will view the scheduled services displayed by the hauler application and travel to the first customer location 3003 to complete the service. The hauler operator may manually remove the stop from the list after completing the service (e.g., via swiping it away), or the system may do so automatically. During travel, the hauler application may assist the operator in safely and efficiently reaching the customer location 3003.

The services schedule list may provide a visual and/or audible indication that a particular stop is the next service stop 3003. For example, the next stop may appear at the top of the list and/or may appear in different colors, fonts, and/or sizes than other stops.

Upon determination that the vehicle has serviced a particular service stop, that stop may be removed from the list and a new stop may be displayed as the next stop. Before removing a stop from the list, the system may provide a visual indication (e.g., italicized text) to make the operator aware that the stop will be removed.

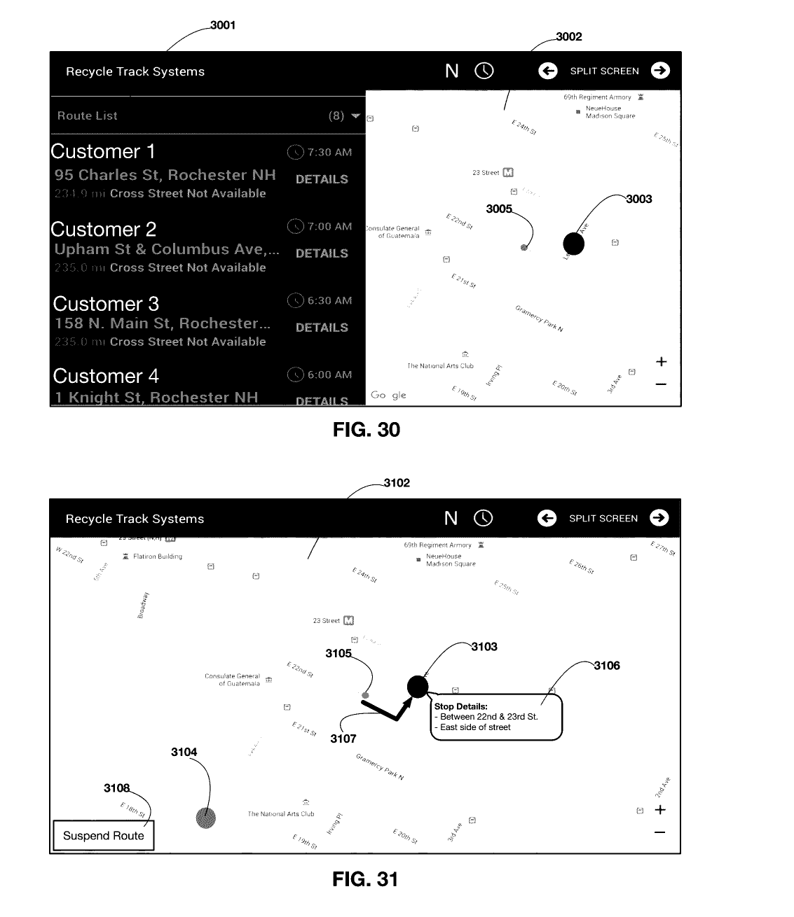

Referring to FIG. 31, an exemplary navigation screen for a hauler vehicle application is illustrated. The navigation screen may present calculated (optimized) turn-by-turn driving instructions to a hauler vehicle 3107, for example on a map interface 3102. The map may display the driver's current location 3105, and any number of scheduled customer stops (3103, 3104). Moreover, this screen may present service stop details 3106, such as but not limited to cross streets and/or the side of a street where a stop is located.

In one embodiment, the navigation screen may provide a visual and/or audible indication that a particular stop is the next service stop 3103. For example, the next service stop 3103 may be displayed as a different icon, color and/or size than other service stops 3104.

Additionally or alternatively, the system may provide a similar visual and/or audible indication upon detection that: a hauler vehicle is traveling in a direction away from the next service stop; a stop is a priority stop; the pickup window for a stop is about to end; the pickup window has ended and/or a customer is not available; and/or a vehicle has missed a stop. For example, the application may determine that a stop has been missed when a vehicle enters a certain area or zone in which the service stop is located and then leaves the zone without traveling to the service location. In this case, the missed stop and/or surrounding area on the displayed map may change from one color to another. The system may provide an option to suspend a route 3108, so that the driver may make an unscheduled stop without the system incorrectly marking stops complete and/or providing alerts of missed stops.

As discussed below, the system may automatically determine an optimized route for the vehicle. Alternatively or additionally, such route may be manually input by a user of the waste management application.

In certain circumstances, the hauler vehicle may need to bring picked up waste to a disposal location for weighing and proper disposal. In such instances, the hauler application may display one or more disposal locations to the operator and/or turn-by-turn directions to the location as discussed above.

In one embodiment, the hauler application may ask the hauler operator to indicate when he is en route to a scheduled service location. For example, the operator may select an “en route” button or link to indicate that he is on his way to the service location. As discussed below, this information may be sent to the waste management application and/or dispatcher application and this information may be used by the system to transmit an estimated time of arrival to the customer via a customer application.

### Customer Application

In one embodiment the waste management system comprises a customer application installed on (or accessed by) one or more client devices, each device associated with a customer. The customer application may be in the form of a desktop or mobile app and/or web app. A user may download the customer application via their mobile device (e.g., Google Play Store or Apple App Store) or may navigate to a web URL using an internet browser. The customer application may communicate with the server via a network, such as a cellular network or Wi-Fi network.

Generally, the customer application allows a customer to create, update and/or view waste management services for their locations. A customer application may allow customers (i.e., individuals and/or businesses) to place requests for waste management services through the application. Customers may identify a service location and, optionally, waste items to be picked up and/or equipment to be dropped off at the location. Such order information may be transmitted to the waste management application via a network. The customer application may also provide notifications, confirmations and/or reports to the customer regarding scheduled waste management orders.

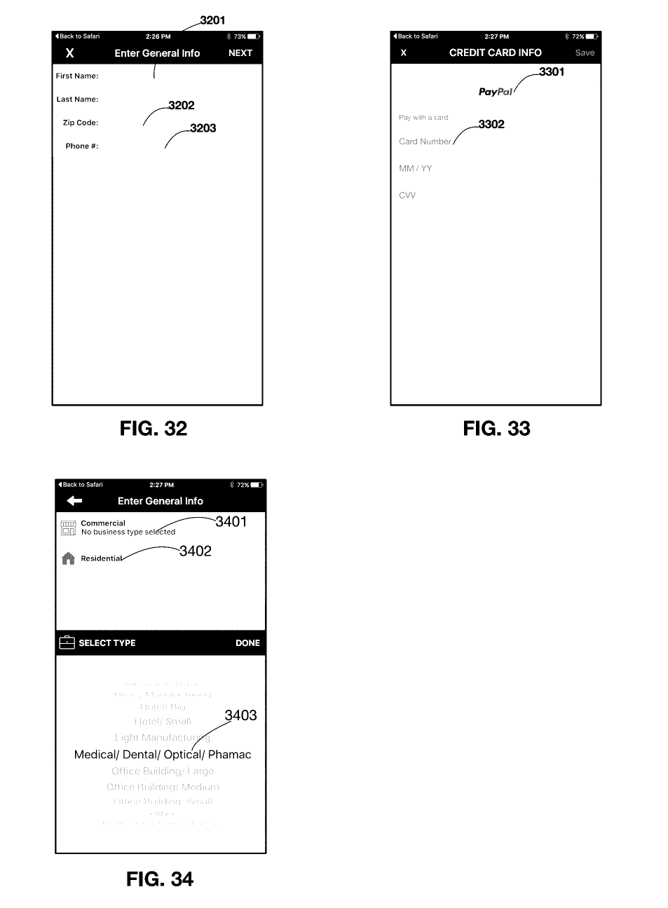

Referring to FIG. 32, an exemplary sign-up screen for a customer application illustrated.

The user may enter user information, such as their name 3201, address 3202, email address and/or phone number 3203. Such information is transmitted to and/or stored by the waste management application.

Referring to FIG. 33, an exemplary billing information screen for a customer application is illustrated. The user may enter billing information such as credit card information 3302 and a billing address. Alternative payment methods 3301 may be used, such as PayPal, Stripe and the like. Such information is transmitted to and/or stored by the waste management application.

Referring to FIG. 34, an exemplary user-type selection screen for a customer application is illustrated. In one embodiment, the user may indicate that they are a commercial customer (e.g., owner or employee of a business) 3401 or a residential customer (e.g., an individual) 3402. Such information is transmitted to and/or stored by the waste management application.

As shown, a commercial customer may be prompted to select a business type 3403 that best describes their business. The business type information may be employed by the system to filter options displayed to the customer, such as the type of waste to be picked up at the customer's location. Such information is transmitted to and/or stored by the waste management application.

Referring to FIG. 35, an exemplary dashboard screen for a customer application is illustrated. The customer dashboard may display news 3501 and/or dynamic updates 3502 relating to, for example, the customer application, scheduled pickups, and/or completed pickups. The dashboard may also include marketing information (discounts, advertisements, tips/service information, waste management company news, etc.), customer information, billing information, alerts, upcoming events, fun facts, service notes and/or legislation news.

As shown, the exemplary dashboard includes a link to request a service 3520, such as waste removal or equipment drop off (“Start a Pickup”). The dashboard may also include a link to a settings page 3510 and/or customer profile page.

In one embodiment, the dashboard may display one or more customer reports and/or customer metrics. For example, the dashboard may show reports received after successful waste removal detailing the amount and type of waste recycled. As another example, the dashboard may show one or more graphs or charts detailing the number of recent completed services.

Referring to FIG. 36, an exemplary settings screen for a customer application is illustrated. The settings page includes links to edit and/or add customer information, such as but not limited to: user account information 3611; customer location 3612; password 3613; and/or billing information 3615. The settings page may also include an option to leave feedback 3614 for the application developer or owner (“Leave RTS Feedback”) and/or links to legal documents 3616.

The customer application may allow customers to schedule waste management services. Generally, a customer enters a service request via the customer application and the request is transmitted to the waste management application for scheduling.

It will be appreciated that, although a waste pickup service is discussed below, the system allows for the scheduling of any number of waste management services including waste services (pickup); equipment services (pickup and/or drop off); and/or maintenance services (e.g., fixing containers and/or cleaning up after a pickup). Moreover, the system allows for the scheduling of one-time services and/or recurring services.

To begin the waste removal scheduling process, the user may select the “Start a Pickup” link (see FIG. 32 at 3220). Upon selecting the link, a user may be prompted to select a location where they would like waste to be picked up by a hauler vehicle.

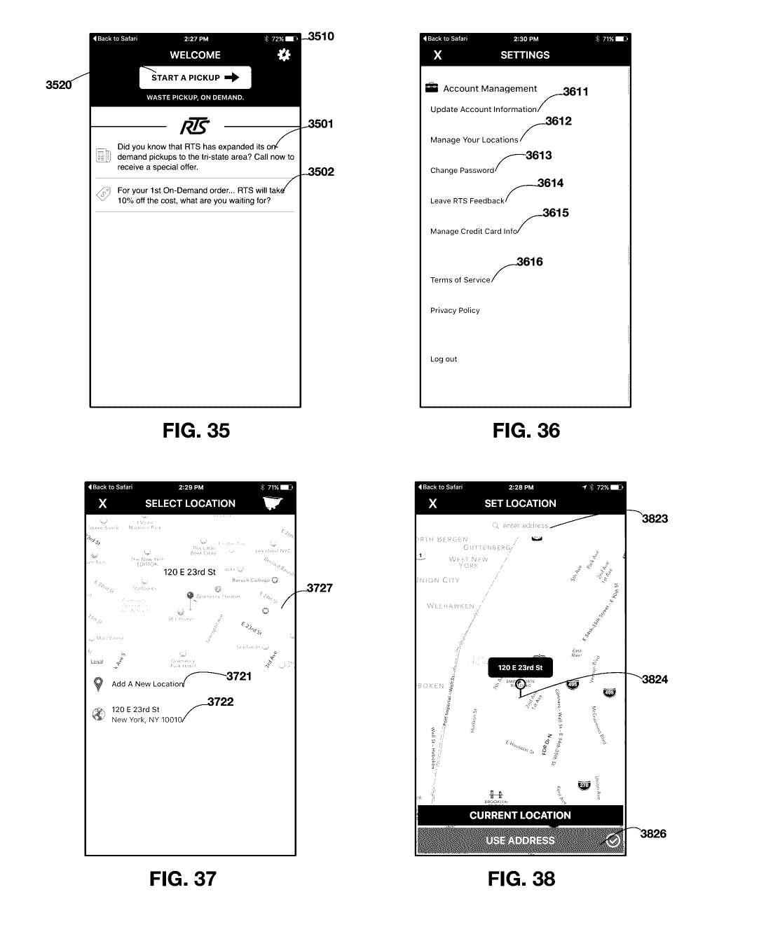

Referring to FIG. 37 and FIG. 38, exemplary screens relating to customer location selection and location settings for a customer application are illustrated. As shown in FIG. 37, the user may enter one or more locations where they would like a service to be performed 3721 or they may select a previously stored location 3721.

If the user adds a new location, they may be taken to a location details screen (FIG. 38).

The customer may then search for a location 3823 or the system may determine the current location of their device 3824. Once the correct location is inputted, the user may enter the location into the system by selecting a “Use Address” button or link 3826. Entered customer locations may be transmitted to and/or stored by the waste management application.

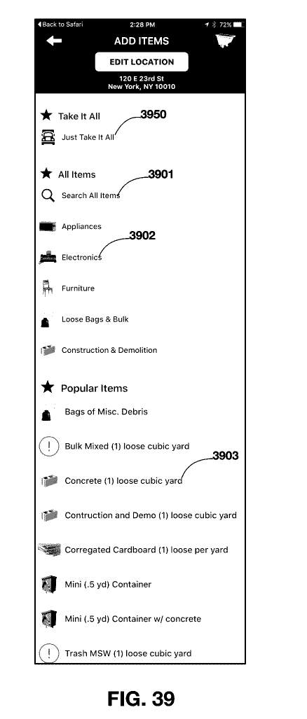

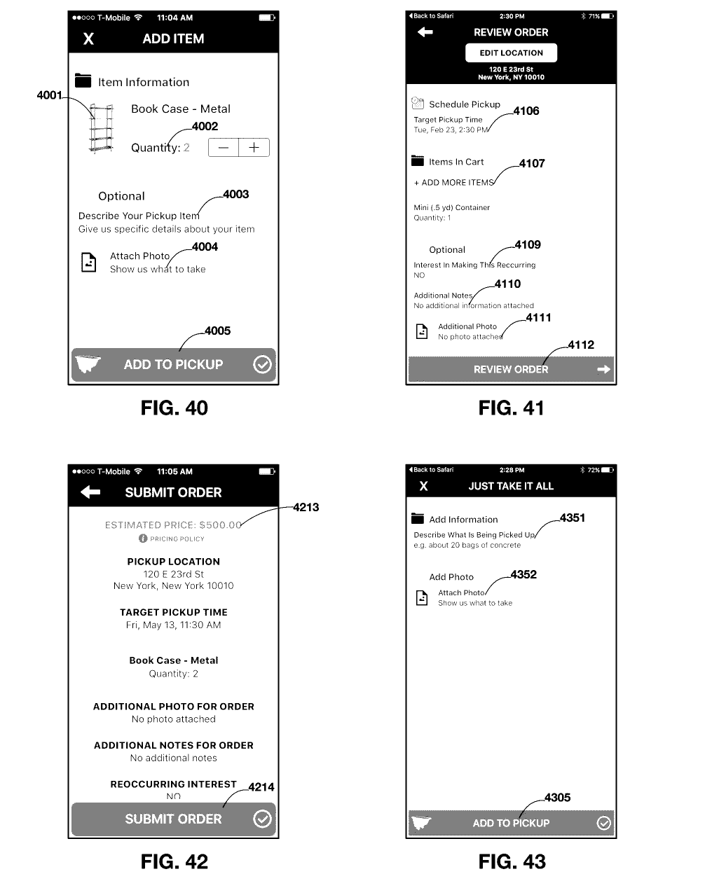

Referring to FIG. 39, an exemplary waste item selection screen for a customer application is illustrated. As shown, a number of waste categories 3902 and/or specific waste items 3903 may be displayed to the user for selection. The user may select one or more of the listed items to continue the selection process (see FIG. 40). The item selection screen may also include a search option 3901 to allow the user to search for and select waste items.

In one embodiment, the user may select one of the listed waste categories 3902 to see a number of waste items within the category. The user may then select a specific item 3903 that they want to picked up, from within the category.

In one embodiment, the waste item selection screen includes a “Just Take It All” option 3950. As discussed below in reference to FIG. 43, this option allows the customer to skip waste item selection, and indicates to the system that the customer wants to order a hauler to pick up all waste at the customer's location.

Referring to FIG. 40, an exemplary waste item details screen for a customer application is illustrated. This screen may be displayed to a user upon selection of a waste item. The waste item details screen may display stored waste information pertaining to the selected item, such as an exemplary image 4001 and/or price information.

As shown, the customer may add and/or edit additional waste information for the item. The user may enter a description of the item and/or special instructions for the hauler vehicle to follow 4003. The user may also take one or more pictures of the item with his mobile device and attach the images to the service request 4004. Moreover, the user may indicate the quantity 4002 of the selected item that he would like to be picked up. The user may confirm his selection by selecting the “Add to Pickup” option 4005.

Referring to FIG. 41, shows an exemplary waste management service request details screen for a customer application is illustrated. As shown, the user may select the “ADD MORE ITEMS” option 4107 to add additional items to his order. The process to add more items is substantially similar to the process described above.

If the user is done adding items, he may schedule a time and date 4106 for the waste to be picked up by a hauler vehicle. The user may simply enter a specific time or a time range during which they would like their waste picked up. Alternatively or additionally, the user may indicate that they would like to make the order recurring (e.g., daily, weekly, monthly, etc.) 4109.

The user may enter any notes and/or special instructions 4110 relating to the order. The user may also take one or more pictures with his mobile device and attach the images to the order 4111. Once the customer is finished entering information, he may choose the “Review Order” option 4112 to view a service request submission screen (FIG. 42).

In one particular embodiment, a user who adds a first category of waste (e.g., and electronic waste item) that requires a first type of vehicle for removal and a second category of waste (e.g., a non-electronic waste item) that requires a second type of vehicle for removal may receive a special notification. Such notification may alert the user that two vehicles may be required to pick up the user's items, resulting in an increase to any minimum price.

In another particular embodiment, a user who adds a restricted waste item may receive a special notification. Exemplary restricted items may include Freon-containing items, mattresses, sheets, medical waste and others. As an example, a user who adds a refrigeration item, may receive a notification explaining that the Freon must be removed before it can be picked up (and it may need to be done by someone other than the hauler operator). As another example, a user who adds a mattress may receive a notification explaining that it must be placed into a plastic bag before it can be picked up for health and safety reasons.

Referring to FIG. 42, an exemplary waste management service request submission screen for a customer application is illustrated. This screen displays a summary of the user's order. As shown, the system may also display an estimated price for the service (discussed in detail above) 4213. In certain embodiments, the system may display a minimum price, maximum price, estimated price and/or range of potential prices.

Finally, the customer may select the “Submit Order” option 4214 to place the pickup order. The order may be transmitted to a waste management application where it is processed and eventually routed to a hauler vehicle. Upon successful submission of a service request, a confirmation screen may be displayed to the user.

Referring to FIG. 43, an exemplary “take it all” screen for a customer application is illustrated. Generally, the user may skip the item selection process by choosing the “take it all” option on the waste item selection screen (see FIG. 39 at 3950). This indicates to the system that the user wants a hauler to pick up all waste at the customer's location.

As shown, the customer may add additional details to a “take it all” order. The user may enter a description 4351 of any waste items to be removed and/or special instructions for the hauler vehicle operator to follow. The user may also take one or more pictures of the waste with his mobile device and attach the images to the order 4352. Once the user adds the “take it all” service 4305, he may be navigated to the waste management service request submission screen FIG. 42, where he can review, edit and/or submit the order.

### Waste Management Services Provider Application

In one embodiment the system comprises a waste management services provider application (also referred to as a “company application,” “dispatcher application” and “provider application”). The provider application may be installed on (or accessed by) one or more client devices, each device associated with a user (e.g., a dispatcher) belonging to a waste management services provider. The provider application may be in the form of a desktop or mobile application and/or web application. A user may download the provider application via their mobile device (e.g., Google Play Store or Apple App Store) or may navigate to a web URL using an internet browser. The provider application may communicate with the server via a network, such as a cellular network or Wi-Fi network.

Generally, the provider application allows a company user (e.g., a dispatcher) to manage hauler vehicle schedules. A user may utilize the provider application to review customer service requests, assign such requests to their hauler vehicles, and/or track hauler vehicle location and/or progress.

Referring to FIG. 44, an exemplary dashboard screen for a services provider application is illustrated. As shown, the dashboard may display information relating to tasks 4410 (discussed below in reference to FIG. 46) and services 4430. For example, the dashboard may present task information, such as new task messages 4411 and tasks in-progress 4412. The dashboard may also include a link to allow a user to create a new task 4413.

The dashboard may present information relating to services, such as but not limited to: requested services that require an action 4431; scheduled services that require an action; requested services that are tentatively scheduled, but require approval (e.g., by a hauler vehicle and/or a different user) 4432; requested services that were tentatively scheduled, but were then rejected by a hauler vehicle and require re-scheduling 4433; scheduled services not requiring an action 4434; completed services 4435; and/or canceled service requests 4436. Exemplary actions include, but are not limited to: scheduling a requested service; approving a tentatively scheduled service; contacting an admin, another provider user, a customer, and/or a hauler vehicle operator; providing an updated price estimate; and others. The screen may indicate which services and/or service requests require action by the user 4421 in a “My Orders” section 4420. A user may add a new service request and/or schedule a new service by selecting a “Create Service Request” option 4422.

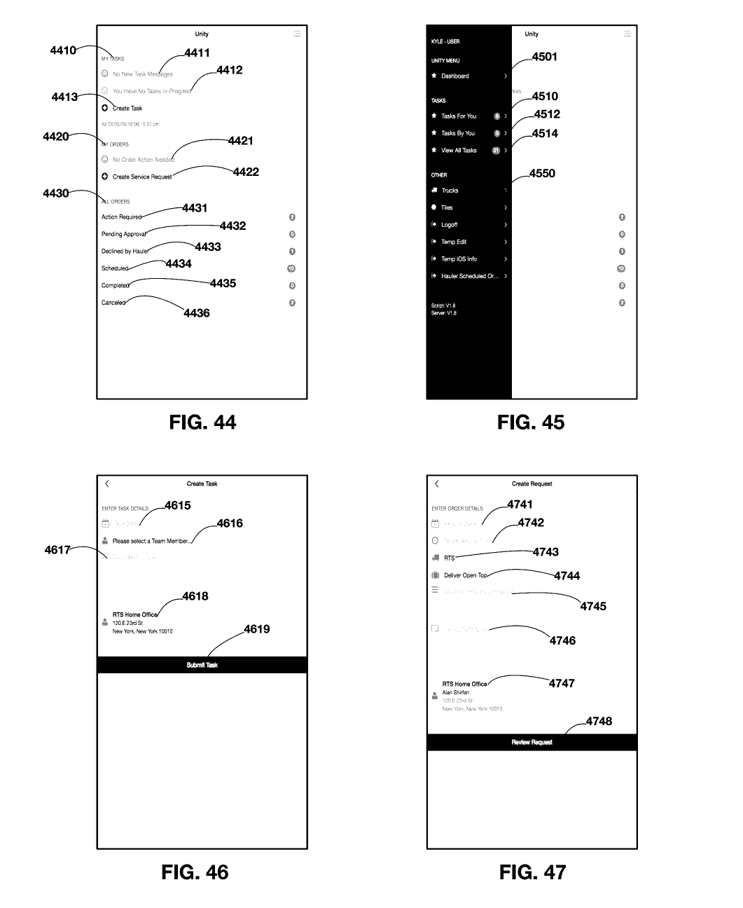

Referring to FIG. 45, an exemplary main menu screen for a services provider application is illustrated. The main menu screen may include links to one or more of: dashboard 4501; tasks (e.g., tasks assigned to the user 4510, tasks assigned to others by the user 4512, and/or all tasks 4514); and/or vehicle information 4550, including vehicle schedules for hauler vehicles associated with the provider and/or accessible by the user.

In one embodiment, the application may provide a list of the hauler vehicles associated with the provider and/or accessible by the user. The user may select a vehicle to view that vehicle's vehicle information and/or service-related information (e.g., completed stops, outstanding stops, missed stops, etc.). The application may provide a list-view or map-view showing current and/or historical location information for the vehicle. For example, the user may view the current location of the vehicle in real time or near-real time. As another example, the user may also view the selected vehicle's daily route and/or routes for previous days.

In certain embodiments, the main menu screen may provide a link to a settings screen where the user can edit their user information (e.g., username, password), contact information, billing information, company information, etc. The settings screen may also allow a user to change a number of settings, such as notification preferences.

Referring to FIG. 46, an exemplary task creation screen for a services provider application is illustrated. As shown, a user may create a new task for a particular customer by selecting a customer 4618, entering a due date 4615 and task description 4617. The task may then be assigned to another user associated with the waste management services provider's account (i.e., a team member) 4616. Once the user has entered all task information, they may submit the task by selecting a submit task button or link 4619.

When a team member is assigned a task 4616, they may receive a notification (e.g., SMS, email, push notification, etc.). They may then login to the provider application to send/receive comments pertaining to the task. In certain embodiments, the team member may assign the task to a new person (e.g., the original task creator and/or a different team member) or add a new person to the task as a follower (e.g., by directing a new comment to them).

Referring to FIG. 47, an exemplary service request creation screen for a services provider application is illustrated. This screen allows a user to create a new service request for a particular customer 4747 and assign the same to an available hauler vehicle 4743. As shown, the user may enter any of the following service information: customer information 4747 (including service location); service date 4741; target service time and/or time window 4742; service type 4744; assigned hauler vehicle 4743; additional service description 4745; and/or any internal notes 4746.

Upon entering all information, the user may select the “Review Request” button or link 4748 to be taken to a final review screen. If all information is correct, the user may create the service request, which may then be transmitted from the provider application to the server.

In certain embodiments, the system may send a notification to the operator of the hauler vehicle to which the service request is assigned. The notification may be transmitted from the waste management application server to the hauler vehicle device. And such notification may be displayed via the hauler vehicle application with a request to accept the service request.

If the operator accepts the service request, the order is confirmed and may be automatically or manually added to the vehicle's outstanding service stops. Upon confirmation, the provider application user may receive a notification and the service may be categorized as “scheduled.” Moreover, the customer may also receive a notification, which may include vehicle information, service information, estimated pricing, etc. (as described in detail below).

If the operator rejects the service request, the provider application user may receive a notification and the request may be categorized as “action required” and/or “declined by hauler.” The user may then assign the request to a different hauler vehicle, as described above.

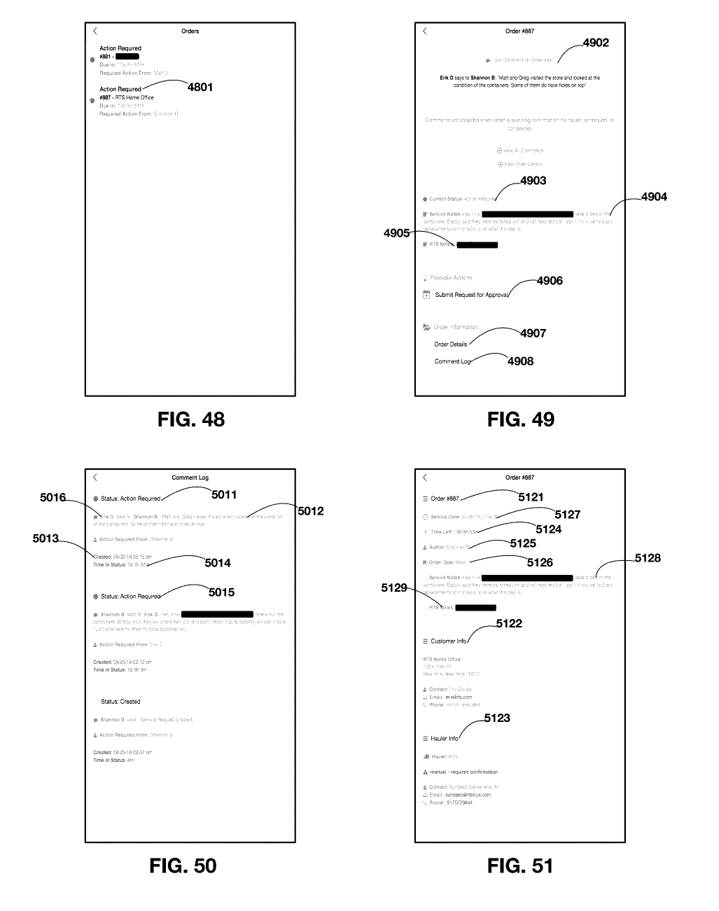

Referring to FIG. 48, an exemplary services list screen for a services provider application is illustrated. This screen may be accessed by, for example, selecting the orders under the “action required” category displayed in the dashboard (see FIG. 44 at 4431). As shown, each scheduled service and/or requested service 4801 in a particular category may be displayed along with one or more of: an order number, a location, a person who needs to take an action, and a time by which the action must be taken.

Referring to FIG. 49, an exemplary order overview screen for a services provider application is illustrated. As shown, information about the service may be displayed such as: recent comments relating to the service 4902, service status 4903, service notes 4904, and/or internal notes 4905. The service overview screen may also present a number of relevant links, such as links to: view service details 4907; view a comments log 4908; submit a service request for approval and/or schedule a service request 4906.

Referring to FIG. 50, an exemplary comment log screen for a services provider application is illustrated. The application allows users to send and receive comments about orders 5012. As shown, each comment may be displayed, along with information about the comment sender 5016, the time the comment was sent 5013, a status of the service at the time the comment was sent 5011 and/or an amount of time the service has been assigned the listed status at the time the comment was sent 5014.

Referring to FIG. 51, an exemplary service details screen for a services provider application is illustrated. The order details screen may present information about an order, such as: order number 5121, service date 5127; time remaining before deadline 5124, service creator information 5125, service type 5126, customer information (including service location) 5122, hauler vehicle information 5123 relating to a hauler vehicle assigned to perform the service, service notes 5128, and/or internal notes 5129.

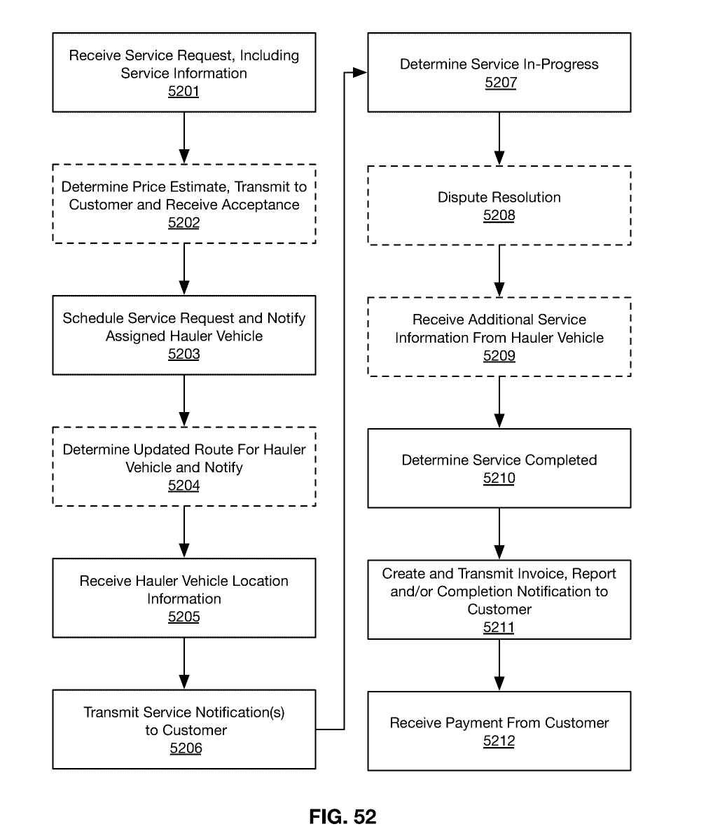

Referring to FIG. 52, an exemplary waste management service scheduling method is illustrated. At step 5201, a service request associated with service information is received. As discussed above, the service request may be received from a customer (e.g., via the customer application) or from a dispatcher (e.g., via the provider application), or the request may be manually entered into the waste management application. In one embodiment, a service may be automatically created and populated with service information from a received service request.

At optional step 5202, the received service request information may be used to manually and/or automatically determine a price estimate for a customer. For example, a customer transmit a service request including a number of waste items they would like picked up, and the system may calculate a price estimate based on the waste items. The price estimate may be transmitted to the customer so that they can accept the estimate to schedule the service or reject the estimate to cancel or modify the service.

The price may be calculated by the system based on a number of variables including, but not limited to: each selected item, the quantity of each item, customer location, type of customer, selected pickup time, hauler vehicle availability, recurring status of order, number of orders by the customer, customer-specific pricing, discounts/promotional codes, a limited time window and/or an imminent time window. Additionally or alternatively, the price may also depend on seasonality (i.e., by business type). For instance, restaurants with outdoor seating see a lot less business in the winter.

In certain embodiments, the system may provide a minimum price, maximum price, estimated price and/or range of potential prices. Moreover, for orders that include multiple services, the price estimate may include a breakdown of the cost per service (e.g., waste item pickup, equipment drop off, etc.).

In embodiments where the service request includes service notes, the system may employ natural language processing to determine the items to be picked up and then determine the price based on these items. Additionally or alternatively, if the service request includes one or more images, the system may employ image recognition technology to determine the items to be picked up and then determine the price based on these items. For example, the volume of the item may be estimated from the photo. The volume of the item may then be multiplied by its estimated density to determine a price for the customer and/or a price for the hauling company.

In one embodiment, the system may present adjusted prices to different users. For example, a random number generator may be “seeded” with a number/string of characters. Such seeding may allow the generator to produce the same result for a given input. For instance, if the generator is seeded with “X”, and asked “pick a number between 1-10” and it says “8”, then seeded again with “X” and asked again, it will say “8” again. However, when seeded with “Y” it will generate a different random number.

Accordingly, a unique item ID (e.g., number/string) may be associated with each item in the database, and a unique customer ID (e.g., number/string) may be associated with each customer on account generation. When a customer requests an estimated price for an item, the random number generator is seeded with the customer ID and item ID and returns a price within a predetermined price range. This allows for the following:
The price for an item is always the same for a particular customer
The price for an item may be different for each customer
The price displayed to any customer is always within a predefined range.

It will be appreciated that the actual price charged for an item may be the same for each customer. In other words, the above adjusted price may only be displayed for price estimates.

At step 5203, the service is scheduled and assigned to a hauler vehicle. Generally, the system may send scheduled service information to a hauler vehicle operator (e.g., to a hauler device running a hauler vehicle application). For example, the system may transmit the scheduled service to a hauler vehicle's pickup list in the hauler vehicle application along with a notification.

In one embodiment, a service may be manually scheduled by a user, such as a waste management company user and/or an admin user who has access to a number of hauler companies and customers. For example, a dispatcher associated with a company may assign a service request to one of the company's hauler vehicles, but may not assign the request to a different company's vehicles. As another example, an admin user may assign the service request to a hauler vehicle associated with any company.

In other embodiments, received service requests may be automatically assigned to a hauler vehicle. Such scheduling may be determined for a single vehicle or for multiple vehicles, and may be determined for a single route or for multiple routes spanning one or more days. It will be appreciated that, although the system may automatically assign services to vehicles, the system may allow a user to add/remove services to/from a vehicle and/or move services between vehicles.

In order to automatically schedule a service, the system may take into account a number of variables, including but not limited to: service information; customer information; company information; vehicle information; routing information (traffic, street closures, streets available to particular vehicles); and/or financial information (e.g., price for service and/or cost to perform service).

For a single hauler vehicle, the system may attempt to schedule existing services to minimize the total distance traveled and/or travel time of the vehicle. The system may provide an optimized service order and/or optimized driving route to/from each of the service locations.

For multiple hauler vehicles, the system may attempt to schedule existing services to minimize the total distance traveled by each vehicle and/or the travel time for each vehicle. The system may determine which vehicle is to perform each of the services. And upon determining the stops for each vehicle, the system may then provide an optimized service order and/or optimized driving route to/from each of the service locations.

In one particular embodiment, the system may determine the services for each vehicle by organizing such services according to service time, service location and/or a required vehicle type for each service. A mapping of the services during particular times may be generated and such mapping may be broken down into a grid system. The system may act to break up the grid system into smaller and smaller parts until each of the parts hold a roughly equal number of service stops. Each of the vehicles may then be assigned to the stops within a particular grid part. Optionally, any stops located on the edge of two grid parts may be automatically assigned to one of the vehicles in order to minimize a total distance traveled and/or total time to complete all services of one or more vehicles. Once each of the stops are assigned to a vehicle, the system may then generate an optimized route for each vehicle (i.e., service order and/or driving route to/from each service location).

In an alternative embodiment, one or more unique location boundaries may be set for each of the waste management vehicles. The system may then assign all services within a particular boundary to the vehicle associated with that boundary.

In one embodiment, the system may break a particular day up into a number of time periods (e.g., 2, 3, 4, 5, 6, 7, 8, 9, 10, 11 or 12 hours) and associate each service with a time period. The new service may then be assigned to a vehicle based on the service time period, and any other service information (e.g., service type, required vehicle type, service location, etc.). The assignment of a new service to a vehicle may be determined to minimize a total distance traveled of multiple vehicles and/or total time traveled of all vehicles. Upon addition of a new service, an updated, optimized route may be determined and provided to the vehicle operator via the hauler application.

In certain circumstances, the hauler vehicle may need to bring picked up waste to a disposal location for weighing and proper disposal. In such instances, system may determine one or more disposal locations and/or may provide turn-by-turn directions to the location as discussed above. The system may determine an optimal disposal location based on physical location, price and/or type of waste accepted by the disposal location.

At optional step 5204, a new service may be assigned to a hauler vehicle while the vehicle is already out performing services. In this case, an updated, optimized route with the new service may be determined. The new route may include an updated service stop order and/or updated driving directions to/from each service location, and such

Additionally or alternatively, if conditions change (e.g., traffic patterns, inclement weather, road closures, service additions, etc.), the system may automatically make adjustments to a vehicle's optimized route and such changes may be pushed to the hauler vehicle application. This may be done as described above, however only services that have not-yet been completed may be used in the optimization calculation. Alternatively, the system may simply determine the next closest stop that is within a given time window, while pushing stops with time windows that are coming to an end to the top of the list. This information may be transmitted to a hauler vehicle operator, e.g., via the hauler application.

At step 5205, hauler vehicle location information is received. As explained above, each vehicle is outfitted with an electronic device having a GPS or other location sensor capable of triangulating the position, speed, and/or direction of the electronic device (and, therefore, the vehicle). Such location information may be received and/or stored by the system.

In one embodiment, the system may automatically detects that a vehicle is en route to a service location without any input from the vehicle operator. In another embodiment, an indication that a vehicle is en route to a scheduled service may be received from the hauler vehicle application.

At step 5206, the system may send any number of notifications to a customer (e.g., via a customer application installed on a customer's mobile device). For example, once the customer places an order, he may receive one or more notifications confirming the order and/or detailing any problems with the order.

A reminder may be transmitted to the customer at some predetermined time before a service is scheduled to be completed (e.g., night before, the day of, etc.). The reminder may include service times, locations, item information, equipment information and/or instructions for the user.

A notification may also be transmitted to the customer once the vehicle is en route to the service location. The notification may include an estimated time of arrival (ETA) based on a location of the designated hauler vehicle and/or based on the operator manually indicating that he is en route. The ETA may alternatively or additionally be based on other variables, such as the number of stops to be completed before the customer's service and/or the amount of time it takes to service each stop.

An additional notification may be transmitted when the vehicle arrives at the scheduled pickup location. Such notification may include vehicle information associated with the vehicle that is completing the service. For example, the notification may include an image of the vehicle and/or information about the vehicle operator (e.g., name and/or image).

At step 5207, the system determines the service is in progress. In one embodiment, the system may automatically detect that a service is being performed and may record information related thereto, such as service start time, service end time and service duration. Such information may be determined without any input from the vehicle operator.

In another embodiment, the system may automatically detect such variables, but will ask the operator to confirm that he has started to perform the service. In yet another embodiment, the vehicle operator may be required to enter such information and/or may be required to confirm that a service is in progress, without a prompt from the waste management system.

At optional step 5208, the system may facilitate dispute resolution. In certain situations, a dispute may occur with respect to the amount that will be paid for waste management services. For example, a hauler vehicle operator may assert that a customer has underestimated the number of items to be picked up or has mischaracterized large items as small items.

The system is adapted to receive dispute resolution information from a hauler vehicle (e.g., via a hauler vehicle application). In one embodiment, the hauler vehicle operator may take a photo of a customer's waste with a hauler device and/or a separate mobile device, and then transmit the same to the waste management system. Additionally, if the hauler vehicle comprises a scale, the operator may weigh the waste and transmit the weight to the waste management system.

Upon receipt of dispute resolution information, an adjusted price may be calculated. For example, an adjusted price may be automatically calculated by the system and/or by a waste management company user or admin user.

A notification may then be transmitted to the customer, notifying them of the dispute. Such notification may include, for example, an explanation of the dispute, the adjusted price for the service and/or any received images. The notification may also present a number of options to the customer, including options to: accept the adjusted price; reject the adjusted price and cancel the service; and/or enter instructions for the hauler vehicle to complete only a portion of the service (e.g., to pick up 2 of 5 items or to drop off 1 of 2 requested pieces of equipment).

If the customer rejects the adjusted price, the service will not be completed. If the customer accepts the adjusted price, the service will be completed, and the customer will be charged and/or receive communications as described below. If the customer requests only a portion of the service to be completed, that portion may be completed and the customer may be billed accordingly.

The customer may make a selection, and such selection may be transmitted to the waste management system. The system may then notify the hauler operator (e.g., via the hauler application) and he may take appropriate action.

At optional step 5209, the system may receive additional service information from a hauler vehicle. For a waste removal service, once the vehicle operator arrives at the service location, the hauler application may present a screen to allow the operator to manually enter waste information (e.g., waste category, waste material, waste quantity and/or waste mass). Such manual input may be necessary, for example, if the customer does not provide the information while ordering. Once the waste information is entered, it may be transmitted to the waste management application for pricing/billing and/or reporting.

Alternatively, the hauler vehicle operator may determine the weight of the waste by taking it to a weigh station, where they typically receive a ticket showing weight details. The ticket may be entered into the hauler application by the operator (manually or by taking a picture of the ticket) and a digital representation may be transmitted to the waste management system. In another embodiment, the hauler vehicle may include a scale to directly measure the weight of the waste and such measurement may be communicated to the waste management system.

In certain embodiments, vehicle information may be received while a vehicle is en route to a disposal location. For example, the system may determine a starting time, an ending time, a duration, a route taken, an average speed and/or other variables relating to the vehicle's trip from the customer location to the disposal location. Such information may be stored and/or transmitted to the waste management system (e.g., to determine that the waste was properly disposed of). Moreover, such information may be included in any report transmitted to the customer.

At step 5210, the system determines the service is completed. As one example, the system may determine a service is complete when information is received from a vehicle's location device showing it is within a certain distance of a service location. As another example, the system may determine a service is complete when a number of pings from a vehicle location device are received within a certain distance of a service location and within a certain amount of time. As yet another example, the system may determine a service is complete when it is within a certain geofence. Such determination may be made when the vehicle's distance from a service location, multiplied by the location device accuracy, is less than a predetermined geofence distance.

In one embodiment, the system may determine that a pickup service has been picked up from a customer location and disposed of at a disposal location (e.g., a landfill or recycle station). The system may make such a determination based on vehicle information (e.g., location, measured weight, etc.) and/or information received from a hauler application (e.g., a submitted weight ticket).

For stops that are not automatically determined, the operator can manually mark them as complete as an override and this will let customer know it was completed (e.g., with a differently worded notification to the automatic alert). Such information may be transmitted to the system and notifications may be sent to the waste management application and/or dispatcher application with additional information so that users know the stop was manually marked complete. Alternatively or additionally, users of the waste management application and/or dispatcher application may also manually mark services complete from the respective applications.

At step 5211, upon successful completion of the service, a final price may be calculated (discussed above) and the customer may be billed for the service. Moreover, status notifications may be transmitted to users of the waste management application, hauler vehicle application, dispatcher application and/or customer application (i.e., push notifications to the customer application, emails, SMS, and/or calls). Such notifications may include, for example, a notice of completion of the service, including any service details determined by the system or entered via the hauler application; an invoice and/or receipt for the service; a request for feedback; billing information and/or past order details; and/or reorder options.

In one embodiment, the system may create and/or transmit one or more reports to users. A report may include detailed waste information relating to any waste removed, such as but not limited to: waste type; waste amount (e.g., mass, quantity, etc.); waste images; notes; relevant vehicle location history (e.g., pickup location, disposal location); and/or an image of any received receipt from the disposal location (discussed below). The report may similarly include detailed information about any equipment dropped off.

As one example, a waste stream survey report may be automatically or manually created, stored and/or transmitted to one or more users of the waste management system. The report may show diversion from a landfill based on an amount of waste that was estimated (one-time or recurring) from a survey and/or seasonality of waste, along with confirmation that it was not delivered to a landfill through the use of location device data.

As another example, an electronic dump slip may be automatically or manually created, stored and/or transmitted to users. A traditional dump slip, or scale ticket, is received from a waste/recycling facility after dropping off a load. The dump slip typically includes information such as the weight of the vehicle before dumping, the weight of the vehicle after dumping, and the net weight of the contents that were dumped. Weight of the contents is used in reporting and/or pricing/billing. An electronic dump slip may be created by a hauler vehicle operator by entering the information from the traditional dump slip into the hauler application and/or by taking a picture of the traditional dump slip.

As yet another example, a recycling report may be created, stored and/or transmitted to users. A recycling report may show energy, water, greenhouse gas (“GHG”), and/or landfill space savings. In certain embodiments, such information may also include information relating to future savings (e.g., how much the customer could save if he did this every X (days/weeks a year) for Y years).

In one embodiment, the customer application may allow the customer to report a missed or incorrectly completed service. Alternatively, the system may automatically detect a missed or incorrectly completed service. In either case, the customer may be notified via the customer application and may be allowed to select a new date/time for the service to be completed. In such a situation, the customer may receive the originally scheduled service for a discount (or free).

In one embodiment, the waste management system may comprise billing and/or payment functionality. As discussed above, the waste management system may store billing information relating to customers and/or waste management companies. Such billing information may include, but is not limited to: a billing contact; billing address; email address; phone number; billing options (e.g., monthly or weekly billing options); credit card information; sub-customer information; and/or customer charges (e.g., monthly charges, volume-based charges, weight-based charges and/or extra charges). Generally, the billing system may be in communication with each of the waste management application, hauler vehicle application, customer application and/or waste management services provider application to allow for billing and/or receipt of payment.

Alternatively or additionally, the waste management system may be in communication with one or more third-party applications, such as but not limited to payment systems, accounting systems, invoicing systems, CRM systems and others. Billing information may be transmitted to and/or received from connected third-party applications. And the waste management system and/or any connected applications may be configured to create and/or send invoices to via email or mail and/or via any of the various applications described herein.

At Step 5212, payment is received from the customer. The waste management system (and/or connected third-party systems) may be configured to accept payment for invoices via credit cards, wire transfers and/or physical checks. Moreover, such systems may be configured to send notifications and/or communications (e.g., push, email, SMS, mail, and/or calls) relating to invoices (e.g., overdue invoice notifications and/or payment received notifications).

Although the various applications are mostly described with respect to waste pickup services, it will be appreciated that the system may be used for efficiently scheduling and tracking equipment drop off and/or pickup services, as well as services requiring both waste pickup and equipment drop off services.

For example, a rolloff vehicle is designed to carry large containers from location to location. These vehicles may perform a number of services, such as: a drop off (e.g., arrive at a location with an empty container and leave it); a removal (e.g., arrive at a location without a container, pick up a waste-filled container, and then dump the contents at a disposal site); a switch (arrive at a location with an empty container, leave the empty container, pick up a waste-filled container, and then dump the contents at a disposal site); and/or a dump and return (arrive at a location without a container, pick up a waste-filled container, dump the contents of the container at a disposal site, return the empty container to the location, and then leave without a container). Rolloff vehicles can also “stage” containers (e.g., drop a container off to a non-final location). Staging allows a vehicle with a container to do a dump and return (e.g., drop the container somewhere, dump and return a container on site, go back and pick-up the container that was “staged”). As such, the system may consider additional variables in order to route such vehicles (e.g., if it does a delivery, it can't do a switch, but it also does not need to dump).

In certain embodiments, the system will always know the contents and/or status of a rolloff vehicle. For example, the vehicle operator may input container contents when they leave a location, or the system may alert the operator as to which container to take. And routing may be based on container contents.

As a specific example, if a vehicle leaves without a container, the system may route the vehicle to a first “pick up” service, then to a “switch” service, then to a “drop off” service, then to “dump and return” service, so they are never making an unnecessary trip back to a container storage facility to pick up another container. The application knows what type of container each site needs, and who owns the container (e.g., the waste management company, the customer, or a third party). The application allows a skilled operator to “stage” containers to minimize routing time. The application also prompts the operator to manually enter and/or take a photo of the dump slip when it detects they are at a waste facility.

Although exemplary systems are described herein in the context of waste management services, it will be appreciated that this specification is not so limited. Indeed, the systems and methods described in this specification may be useful for any type of on-location service. For example, the system may be used by any of the following companies and/or customers to facilitate scheduling and/or tracking of services: telecommunications, internet and cable providers (e.g., equipment installation and/or maintenance); electricity and electrical services providers (e.g., equipment installation and/or maintenance); heating and/or cooling providers (e.g., equipment installation and/or maintenance); water providers (e.g., equipment installation and/or maintenance); delivery and/or pick up services (e.g., food delivery, laundry pick up and/or drop off, mail delivery); moving companies; construction companies (e.g., delivery of supplies, scheduling construction workers to multiple projects); emergency services providers (e.g., firefighters, private security, road-side assistance, etc.); medical service providers (e.g., doctors, nurses, veterinarians, occupational and/or physical therapists, etc.); lodging providers and property managers (e.g., room service, maid service, janitorial service, maintenance services, etc.); transportation providers (e.g., train services, bus services, car services, valet services, vehicle delivery services, etc.); news crew (e.g., to keep track of reporter locations); pest removal services; door-to-door sales representatives; educational service providers (e.g., teachers, music professionals, cooking classes); parking ticket distributors (e.g., to manage streets visited and/or cars viewed/ticketed); and other general repair, cleaning and/or maintenance services (e.g., handyman, cleaning, landscaping, plumbing, towing companies, carpet/flooring installation, floor/ceiling/wall insulation installation, etc.)

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory program carrier for execution by, or to control the operation of, data processing apparatus (i.e., one or more computer programs). Program instructions may be, alternatively or additionally, encoded on an artificially generated propagated signal (e.g., a machine-generated electrical, optical, or electromagnetic signal) that is generated to encode information for transmission to suitable receiver apparatus for execution by a data processing apparatus. And the computer storage medium can be one or more of: a machine-readable storage device, a machine-readable storage substrate, a random or serial access memory device, and combinations thereof.

As used herein, the term “data processing apparatus” comprises all kinds of apparatuses, devices, and machines for processing data, including but not limited to, a programmable processor, a computer, and/or multiple processors or computers. Exemplary apparatuses may include special purpose logic circuitry, such as a field programmable gate array (“FPGA”) and/or an application specific integrated circuit (“ASIC”). In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code). A computer program can be deployed and/or executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a random access memory (“RAM”). The essential elements of a computer are a CPU for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, and/or optical disks). However, a computer need not have such devices. Moreover, a computer may be embedded in another device, such as but not limited to, a mobile telephone, a personal digital assistant (“PDA”), a mobile audio or video player, a game console, a Global Positioning System (“GPS”) receiver, or a portable storage device (e.g., a universal serial bus (“USB”) flash drive).

Computer readable media suitable for storing computer program instructions and data include all forms of nonvolatile memory, media and memory devices. For example, computer readable media may include one or more of the following: semiconductor memory devices, such as erasable programmable read-only memory (“EPROM”), electrically erasable programmable read-only memory (“EEPROM”) and/or and flash memory devices; magnetic disks, such as internal hard disks or removable disks; magneto optical disks; and/or CD ROM and DVD-ROM disks. The processor and the memory can be supplemented by, or incorporated in, special purpose logic circuitry.

To provide for interaction with a user, embodiments may be implemented on a computer having any type of display device for displaying information to a user. Exemplary display devices include, but are not limited to one or more of: projectors, cathode ray tube (“CRT”) monitors, liquid crystal displays (“LCD”), light-emitting diode (“LED”) monitors and/or organic light-emitting diode (“OLED”) monitors. The computer may further comprise one or more input devices by which the user can provide input to the computer. Input devices may comprise one or more of: keyboards, a pointing device (e.g., a mouse or a trackball). Input from the user can be received in any form, including acoustic, speech, or tactile input. Moreover, feedback may be provided to the user via any form of sensory feedback (e.g., visual feedback, auditory feedback, or tactile feedback). A computer can interact with a user by sending documents to and receiving documents from a device that is used by the user (e.g., by sending web pages to a web browser on a user's client device in response to requests received from the web browser).

Embodiments of the subject matter described in this specification can be implemented in a computing system that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Non-limiting examples of communication networks include a local area network (“LAN”) and a wide area network (“WAN”), e.g., the Internet.

The computing system may include clients and/or servers. The client and server may be remote from each other and interact through a communication network. The relationship of client and server arises by virtue of computer programs running on the respective computers and having a client-server relationship to each other.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A computer-implemented method for scheduling and facilitating services comprising:
receiving, by a computer, a service request, the service request associated with service request information comprising:
a customer associated with the request;
a requested service location;
a requested service type; and
a requested service time;
selecting a vehicle to fulfill the service request from a plurality of vehicles,
wherein each vehicle is associated with vehicle information comprising:
one or more allowed customers;
one or more allowed service locations;
one or more allowed service types; and
a service route comprising a number of scheduled service stops, each stop associated with at least a service location and a service time, and
wherein said selecting is based on the service request information and the vehicle information;
determining, by the computer, an updated service route for the selected vehicle, the updated service route including a new service stop corresponding to the service request, the new service stop comprising a service time determined based on the requested service time and the vehicle information of the selected vehicle;
transmitting, by the computer, the updated service route to the selected vehicle;
receiving, by the computer, location information from a location device associated with the selected vehicle; and
determining, by the computer, that the vehicle has completed the new service stop, based on the received location information.

2. A computer-implemented method according to claim 1, wherein:
the requested service type is a waste management service selected from the group consisting of: a waste pickup service, an equipment drop off service; an equipment pick up service and combinations thereof; and
the service request information further comprises one or more of the group consisting of: a customer name; a customer ID, waste type, waste item, waste quantity, waste volume, waste mass, equipment type, equipment quantity, equipment volume, equipment mass, a preferred start time, a window of availability, a start date, an end date, priority information, confirmation information, and notification information.

3. A computer-implemented method according to claim 1, wherein said selecting a vehicle from a plurality of vehicles further comprises:
determining that service request customer is an allowed customer of the vehicle;
determining that the service location is within the one or more allowed service locations of the vehicle; and
determining that the requested service type is one of the allowed service types of the vehicle.

4. A computer-implemented method according to claim 1, wherein:
the vehicle information further comprises one or more of the group consisting of: current vehicle location information, a starting location, and an ending location; and
said selecting a vehicle from a plurality of vehicles is further based on the current vehicle location information.

5. A computer-implemented method according to claim 4, wherein said determining the updated service route is further based on the location information of the selected vehicle.

6. A computer-implemented method according to claim 1, further comprising:
estimating, by the computer, an amount of time required to fulfill the service request, based on the service request information, and
wherein one or both of said selecting a vehicle from a plurality of vehicles and said determining the updated service route is further based on the estimated time required to perform the service.

7. A computer-implemented method according to claim 1, wherein the updated service route is transmitted to a vehicle device associated with the selected vehicle.

8. A computer-implemented method according to claim 1, wherein the location information comprises one or more of the group consisting of: current location, direction of travel, acceleration, accuracy, and vehicle operator input.

9. A computer-implemented method according to claim 1, further comprising determining that the vehicle is en route to the new service stop, based on the received location information.

10. A computer-implemented method according to claim 9, further comprising sending a notification to the customer, the notification comprising an estimated time of arrival (ETA) of the vehicle, the ETA based on the received location information.

11. A computer-implemented method according to claim 1, wherein said determining that the vehicle has completed the new service stop comprises:
determining that the vehicle has traveled to the customer location; and
determining that the vehicle remained at the customer location for at least a predetermined amount of time.

12. A computer-implemented method according to claim 11, wherein said determining that the vehicle has completed the new service stop further comprises determining that the vehicle traveled from the customer location to a waste disposal location.

13. A computer-implemented method according to claim 1, further comprising transmitting instructions to the vehicle to proceed to a next scheduled service stop, upon determining that the vehicle has completed the new service stop.

14. A computer-implemented method according to claim 1, further comprising:
receiving, by the computer, waste information from the vehicle,
wherein the waste information comprises one or more waste items picked up by the vehicle and one or more of the group consisting of: a quantity of the one or more waste items, a mass of the one or more waste items, a volume of the one or more waste items, an image of one or more of the waste items, an electronic waste disposal ticket relating to the one or more waste items, and environmental information relating to the one or more waste items.

15. A computer-implemented method according to claim 14, further comprising calculating, by the computer, a price for the completed service stop, based on the received waste information.

16. A computer-implemented method according to claim 15, further comprising:
transmitting, by the computer, a communication to the customer, the communication comprising one or more of the group consisting of: the calculated price and the waste information received from the vehicle.

17. A system for scheduling and facilitating services, the system comprising:
a plurality of customer devices, each device associated with a customer;
a plurality of dispatcher devices, each device associated with a dispatcher;
a plurality of vehicle devices, each device associated with a vehicle and each comprising a sensor adapted to determine location information for the associated vehicle; and
a server in communication with the plurality of customer devices, the plurality of dispatcher devices and the plurality of vehicle devices via a network, the server comprising:
a memory storing:
the location information associated with each of the plurality of vehicles; and
vehicle information associated with each of the plurality of vehicles, the vehicle information comprising:
one or more allowed customers;
one or more allowed service locations;
one or more allowed service types; and
a service route comprising a number of scheduled service stops, each stop associated with at least a service location and a service time; and
a processor adapted to:
receive a service request from one of the customer devices, the dispatcher devices, or the vehicle devices, the service request including service request information comprising:
a customer associated with the request;
a requested service location;
a requested service type; and
a requested service time;
select a vehicle to fulfill the service request from the plurality of vehicles, based on the received service request information and the stored vehicle information;
determine an updated service route for the selected vehicle, the updated service route including a new service stop corresponding to the service request, the new service stop comprising a service time determined based on the requested service time and the stored vehicle information corresponding to the selected vehicle;
transmit the updated service route to the vehicle device of the selected vehicle; and
determine that the vehicle has completed the new service stop, based on the vehicle's location information.

18. A system according to claim 17, wherein the processor is further adapted to:
calculate a price for the completed service stop; and
transmit a communication to the customer device of the customer associated with the completed service stop, the communication comprising the calculated price.

19. A system according to claim 17, wherein the processor is further adapted to transmit instructions to the vehicle device to proceed to a next scheduled service stop, upon determining that the vehicle has completed the new service stop.

20. A system according to claim 17, wherein the processor is further adapted to:
receive waste information from the vehicle device,
wherein the waste information comprises one or more waste items picked up by the vehicle and one or more of the group consisting of: a quantity of the one or more waste items, a mass of the one or more waste items, a volume of the one or more waste items, an image of one or more of the waste items, an electronic waste disposal ticket relating to the one or more waste items, and environmental information relating to the one or more waste items;
calculate a price for the new service stop based on the waste information received from the vehicle device; and
transmit a communication to the customer comprising one or more of the group consisting of: the calculated price and the waste information received from the vehicle.
